(19) United States
(12) Patent Application Publication
(10) Pub. No.: US 2025/0158770 A1
(43) Pub. Date: May 15, 2025

(54) SOUNDING REFERENCE SIGNAL SLOT SCHEDULES FOR SLOTS WITH MIXED SUB-BAND FULL-DUPLEX AND NON-SUB-BAND FULL-DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Ahmed Attia ABOTABL, San Diego, CA (US); Gokul SRIDHARAN, Sunnyvale, CA (US)

(21) Appl. No.: 18/509,033

(22) Filed: Nov. 14, 2023

(51) Int. Cl. H04L 5/00; H04L 5/14; H04W 72/0446; H04W 72/1268

(52) U.S. Cl. CPC H04L 5/0051; H04L 5/14; H04W 72/0446; H04W 72/1268

(57) ABSTRACT

Some examples of the techniques described herein may provide approaches for scheduling a sounding reference signal (SRS) in a time-division duplex (TDD) structure with one or more mixed sub-band full-duplex (SBFD) slots. For SRS based on physical slot counting, for example, some of the techniques described herein may provide approaches indicating whether to transmit or drop SRS resources in SBFD or non-SBFD symbols in a mixed SBFD slot. For SRS based on available slot counting, for example, some of the techniques described herein may indicate whether a mixed SBFD slot is an available slot for SRS transmission. For duplex-specific SRS, for example, some of the techniques described herein may indicate whether to label or determine a mixed SBFD slot as an SBFD-specific slot or non-SBFD-specific slot, or whether a resource in a mixed SBFD slot may be sent or dropped.

### TECHNICAL FIELD

The following relates to wireless communications, including sounding reference signal slot schedules for slots with mixed sub-band full-duplex and non-sub-band full-duplex symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

In some wireless communication systems, a user equipment (UE) may transmit a sounding reference signal (SRS) to a network entity. Examples of SRS signals may include aperiodic SRS (A-SRS), periodic SRS, and semi-persistently scheduled SRS. The network entity may utilize the SRS to estimate one or more channel characteristics for communicating with the UE. In some examples, the UE may transmit the SRS on one or more uplink symbols in an uplink slot of a time-division duplexing (TDD) pattern. Some TDD slot structures may include one or more mixed sub-band full-duplex (SBFD) slots. A first portion of a mixed SBFD slot may include a frequency band (e.g., a sub-band) for uplink transmissions (e.g., one or more uplink symbols) and a frequency band for downlink communications (e.g., one or more downlink symbols), and a second portion of the mixed SBFD slot may dedicate frequency resources of the slot for uplink communications.

Some examples of the techniques described herein may provide approaches for scheduling SRS in a TDD structure with one or more mixed SBFD slots. For SRS based on physical slot counting, for example, some of the techniques described herein may provide approaches indicating whether to transmit or drop SRS resources in SBFD or non-SBFD symbols when the slot offset from a triggering downlink control information (DCI) indicates a target slot with mixed SBFD and non-SBFD symbols. For SRS based on available slot counting, for example, some of the techniques described herein may indicate whether a target slot with mixed SBFD and non-SBFD symbols is an available slot for SRS (e.g., A-SRS) transmission. For duplex-specific SRS, for example, some of the techniques described herein may indicate whether to label or determine the target slot with mixed SBFD and non-SBFD symbols as an SBFD-specific slot or non-SBFD-specific slot, or whether a resource that maps to both SBFD and non-SBFD symbols may be sent or dropped.

A method by a UE is described. The method may include receiving a schedule for a sounding reference signal resource set, the schedule indicating a slot offset for a target slot relative to a reference slot and transmitting a quantity of sounding reference signals in the target slot, the quantity of transmitted sounding reference signals being based on the target slot including one or more sub-band full-duplex symbols and one or more non-sub-band full-duplex symbols and being further based on one or more sounding reference signal resources of the sounding reference signal resource set overlapping between the one or more sub-band full-duplex symbols and the one or more non-sub-band full-duplex symbols.

A UE is described. The UE may include one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the UE to receive a schedule for a sounding reference signal resource set, the schedule indicating a slot offset for a target slot relative to a reference slot and transmit a quantity of sounding reference signals in the target slot, the quantity of transmitted sounding reference signals being based on the target slot including one or more sub-band full-duplex symbols and one or more non-sub-band full-duplex symbols and being further based on one or more sounding reference signal resources of the sounding reference signal resource set overlapping between the one or more sub-band full-duplex symbols and the one or more non-sub-band full-duplex symbols.

Another UE is described. The UE may include means for receiving a schedule for a sounding reference signal resource set, the schedule indicating a slot offset for a target slot relative to a reference slot and means for transmitting a quantity of sounding reference signals in the target slot, the quantity of transmitted sounding reference signals being based on the target slot including one or more sub-band full-duplex symbols and one or more non-sub-band full-duplex symbols and being further based on one or more sounding reference signal resources of the sounding reference signal resource set overlapping between the one or more sub-band full-duplex symbols and the one or more non-sub-band full-duplex symbols.

A non-transitory computer-readable medium storing code for wireless communications at a UE is described. The code may include instructions executable by at least one processor (e.g., directly, indirectly, after pre-processing, without pre-processing) to receive a schedule for a sounding reference signal resource set, the schedule indicating a slot offset for a target slot relative to a reference slot and transmit a quantity of sounding reference signals in the target slot, the quantity of transmitted sounding reference signals being based on the target slot including one or more sub-band full-duplex symbols and one or more non-sub-band full-duplex symbols and being further based on one or more sounding reference signal resources of the sounding reference signal resource set overlapping between the one or more SBFD symbols and the one or more non-SBFD symbols.

In some examples of the method, UEs, and non-transitory computer-readable medium described herein, transmitting the quantity of sounding reference signals in the target slot may include operations, features, means, or instructions for refraining from transmitting sounding reference signaling via one or more symbols of the one or more sounding reference signal resources overlapping between the one or more SBFD symbols and the one or more non-SBFD symbols.

In some examples of the method, UEs, and non-transitory computer-readable medium described herein, transmitting the quantity of sounding reference signals in the target slot may include operations, features, means, or instructions for refraining from transmitting sounding reference signaling via the sounding reference signal resource set in response to the one or more sounding reference signal resources overlapping between the one or more SBFD symbols and the one or more non-SBFD symbols.

In some examples of the method, UEs, and non-transitory computer-readable medium described herein, the one or more sounding reference signal resources may be restricted from overlapping between the one or more SBFD symbols and the one or more non-SBFD symbols.

In some examples of the method, UEs, and non-transitory computer-readable medium described herein, transmitting the quantity of sounding reference signals in the target slot may include operations, features, means, or instructions for transmitting sounding reference signaling via one or more symbols of the sounding reference signal resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

In some examples of the method, UEs, and non-transitory computer-readable medium described herein, transmitting the quantity of sounding reference signals in the target slot may include operations, features, means, or instructions for refraining from transmitting sounding reference signaling via one or more symbols of the sounding reference signal resource set scheduled in one or more downlink SBFD symbols of the target slot and transmitting one or more symbols of the sounding reference signal resource set scheduled in one or more uplink symbols of the target slot.

Some examples of the method, UEs, and non-transitory computer-readable medium described herein may further include operations, features, means, or instructions for transmitting an indication of a capability of the UE to support available slot offset scheduling, where the schedule indicating the slot offset may be received based on the capability of the UE to support available slot offset scheduling.

In some examples of the method, UEs, and non-transitory computer-readable medium described herein, transmitting the quantity of sounding reference signals in the target slot may include operations, features, means, or instructions for refraining from transmitting sounding reference signaling via the sounding reference signal resource set in the target slot, the target slot being determined as unavailable based on the one or more sounding reference signal resources overlapping between the one or more SBFD symbols and the one or more non-SBFD symbols and transmitting the sounding reference signaling in a next available slot after the target slot.

In some examples of the method, UEs, and non-transitory computer-readable medium described herein, transmitting the quantity of sounding reference signals in the target slot may include operations, features, means, or instructions for transmitting sounding reference signaling, of the sounding reference signal resource set, scheduled in the target slot, the target slot being determined as available based on the target slot including the one or more SBFD symbols.

In some examples of the method, UEs, and non-transitory computer-readable medium described herein, transmitting the quantity of sounding reference signals in the target slot may include operations, features, means, or instructions for refraining from transmitting sounding reference signaling via one or more downlink symbols, of the sounding reference signal resource set, scheduled in the target slot.

In some examples of the method, UEs, and non-transitory computer-readable medium described herein, transmitting the quantity of sounding reference signals in the target slot may include operations, features, means, or instructions for transmitting sounding reference signaling via one or more symbols of the sounding reference signal resource set in the target slot, the target slot being determined as available based on the sounding reference signal resource set not overlapping with one or more downlink resources in the target slot.

In some examples of the method, UEs, and non-transitory computer-readable medium described herein, transmitting the quantity of sounding reference signals in the target slot may include operations, features, means, or instructions for refraining from transmitting sounding reference signaling via the sounding reference signal resource set in the target slot, the target slot being determined as unavailable based on the sounding reference signal resource set overlapping with one or more downlink resources in the target slot.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes refraining from transmitting sounding reference signaling via one or more symbols, of the sounding reference signal resource set, scheduled in a resource of the target slot that does not match the duplex type.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes transmitting sounding reference signaling via one or more symbols, of the sounding reference signal resource set, scheduled in a resource of the target slot that matches the duplex type.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes refraining from transmitting sounding reference signaling via the one or more sounding reference signal resources overlapping between the one or more SBFD symbols and the one or more non-SBFD symbols.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes transmitting sounding reference signaling via one or more symbols, of the sounding reference signal resource set, based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes refraining from transmitting sounding reference signaling via the sounding reference signal resource set in the target slot, the target slot being determined as unavailable in response to the one or more sounding reference signal resources overlapping between the one or more SBFD symbols and the one or more non-SBFD symbols.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes transmitting sounding reference signaling via one or more symbols, of the sounding reference signal resource set, in the target slot, where the sounding reference signaling may be transmitted in the one or more SBFD symbols and not in the one or more non-SBFD symbols, or where the sounding reference signaling may be transmitted in the one or more non-SBFD symbols and not in the one or more SBFD symbols.

In some examples of the method, UEs, and non-transitory computer-readable medium described herein, the sounding reference signaling may be transmitted in the one or more SBFD symbols and not in the one or more non-SBFD symbols of the target slot determined as a sub-band full duplex slot or may be transmitted in the one or more non-SBFD symbols and not in the one or more SBFD symbols of the target slot determined as a non-SBFD slot, based on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot.

Some examples of the method, UEs, and non-transitory computer-readable medium described herein may further include operations, features, means, or instructions for receiving an indication of a duplex type of the one or more sounding reference signal resources of the sounding reference signal resource set, where transmitting the quantity of sounding reference signals in the target slot includes transmitting sounding reference signaling via one or more symbols, of the sounding reference signal resource set, in the target slot, where the sounding references signaling may be transmitted in the one or more SBFD symbols and in the one or more non-SBFD symbols.

A method by a network entity is described. The method may include transmitting a schedule for a sounding reference signal resource set, the schedule indicating a slot offset for a target slot relative to a reference slot and receiving a quantity of sounding reference signals in the target slot, the quantity of received sounding reference signals being based on the target slot including one or more SBFD symbols and one or more non-SBFD symbols and being further based on one or more sounding reference signal resources of the sounding reference signal resource set overlapping between the one or more SBFD symbols and the one or more non-SBFD symbols.

A network entity is described. The network entity may include one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the network entity to transmit a schedule for a sounding reference signal resource set, the schedule indicating a slot offset for a target slot relative to a reference slot and receive a quantity of sounding reference signals in the target slot, the quantity of received sounding reference signals being based on the target slot including one or more SBFD symbols and one or more non-SBFD symbols and being further based on one or more sounding reference signal resources of the sounding reference signal resource set overlapping between the one or more SBFD symbols and the one or more non-SBFD symbols.

Another network entity is described. The network entity may include means for transmitting a schedule for a sounding reference signal resource set, the schedule indicating a slot offset for a target slot relative to a reference slot and means for receiving a quantity of sounding reference signals in the target slot, the quantity of received sounding reference signals being based on the target slot including one or more SBFD symbols and one or more non-SBFD symbols and being further based on one or more sounding reference signal resources of the sounding reference signal resource set overlapping between the one or more SBFD symbols and the one or more non-SBFD symbols.

A non-transitory computer-readable medium storing code for wireless communications at a network entity is described. The code may include instructions executable by at least one processor (e.g., directly, indirectly, after pre-processing, without pre-processing) to transmit a schedule for a sounding reference signal resource set, the schedule indicating a slot offset for a target slot relative to a reference slot and receive a quantity of sounding reference signals in the target slot, the quantity of received sounding reference signals being based on the target slot including one or more SBFD symbols and one or more non-SBFD symbols and being further based on one or more sounding reference signal resources of the sounding reference signal resource set overlapping between the one or more SBFD symbols and the one or more non-SBFD symbols.

In some examples of the method, network entities, and non-transitory computer-readable medium described herein, receiving the quantity of sounding reference signals in the target slot may include operations, features, means, or instructions for refraining from receiving sounding reference signaling via at least one of the one or more sounding reference signal resources overlapping between the one or more SBFD symbols and the one or more non-SBFD symbols.

In some examples of the method, network entities, and non-transitory computer-readable medium described herein, receiving the quantity of sounding reference signals in the target slot may include operations, features, means, or instructions for refraining from receiving sounding reference signaling via the sounding reference signal resource set in response to the one or more sounding reference signal resources overlapping between the one or more SBFD symbols and the one or more non-SBFD symbols.

In some examples of the method, network entities, and non-transitory computer-readable medium described herein, the one or more sounding reference signal resources may be restricted from overlapping between the one or more SBFD symbols and the one or more non-SBFD symbols.

In some examples of the method, network entities, and non-transitory computer-readable medium described herein, receiving the quantity of sounding reference signals in the target slot may include operations, features, means, or instructions for receiving sounding reference signaling via one or more symbols of the sounding reference signal resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

In some examples of the method, network entities, and non-transitory computer-readable medium described herein, receiving the quantity of sounding reference signals in the target slot may include operations, features, means, or instructions for refraining from receiving sounding reference signaling via one or more symbols of the sounding reference signal resource set scheduled in one or more downlink SBFD symbols of the target slot and receiving one or more symbols of the sounding reference signal resource set scheduled in one or more uplink symbols of the target slot.

Some examples of the method, network entities, and non-transitory computer-readable medium described herein may further include operations, features, means, or instructions for receiving an indication of a capability of a UE to support available slot offset scheduling, where the schedule indicating the slot offset may be transmitted based on the capability of the UE to support available slot offset scheduling.

In some examples of the method, network entities, and non-transitory computer-readable medium described herein, receiving the quantity of sounding reference signals in the target slot may include operations, features, means, or instructions for refraining from receiving sounding reference signaling via the sounding reference signal resource set in the target slot, the target slot being determined as unavailable based on the one or more sounding reference signal resources overlapping between the one or more SBFD symbols and the one or more non-SBFD symbols and receiving the sounding reference signaling in a next available slot after the target slot.

In some examples of the method, network entities, and non-transitory computer-readable medium described herein, receiving the quantity of sounding reference signals in the target slot may include operations, features, means, or instructions for receiving sounding reference signaling, of the sounding reference signal resource set, scheduled in the target slot, the target slot being determined as available based on the target slot including the one or more SBFD symbols.

In some examples of the method, network entities, and non-transitory computer-readable medium described herein, receiving the quantity of sounding reference signals in the target slot may include operations, features, means, or instructions for refraining from receiving sounding reference signaling via one or more downlink symbols of the sounding reference signal resource set scheduled in of the target slot.

In some examples of the method, network entities, and non-transitory computer-readable medium described herein, receiving the quantity of sounding reference signals in the target slot may include operations, features, means, or instructions for receiving sounding reference signaling via one or more symbols of the sounding reference signal resource set in the target slot, the target slot being determined as available based on the sounding reference signal resource set not overlapping with one or more downlink resources in the target slot.

In some examples of the method, network entities, and non-transitory computer-readable medium described herein, receiving the quantity of sounding reference signals in the target slot may include operations, features, means, or instructions for refraining from receiving sounding reference signaling via the sounding reference signal resource set in the target slot, the target slot being determined as unavailable based on the sounding reference signal resource set overlapping with one or more downlink resources in the target slot.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes refraining from receiving sounding reference signaling via one or more symbols, of the sounding reference signal resource set, scheduled in a resource of the target slot that does not match the duplex type.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes receiving sounding reference signaling via one or more symbols, of the sounding reference signal resource set, scheduled in a resource of the target slot that matches the duplex type.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes refraining from receiving sounding reference signaling via the one or more sounding reference signal resources overlapping between the one or more SBFD symbols and the one or more non-SBFD symbols.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes receiving sounding reference signaling via one or more symbols of the sounding reference signal resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes refraining from receiving sounding reference signaling via the sounding reference signal resource set in the target slot, the target slot being determined as unavailable in response to the one or more sounding reference signal resources overlapping between the one or more SBFD symbols and the one or more non-SBFD symbols.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes receiving sounding reference signaling via one or more symbols, of the sounding reference signal resource set, in the target slot, where the sounding reference signaling may be received in the one or more SBFD symbols and not in the one or more non-SBFD symbols, or where the sounding reference signaling may be received in the one or more non-SBFD symbols and not in the one or more SBFD symbols.

In some examples of the method, network entities, and non-transitory computer-readable medium described herein, the sounding reference signaling may be received in the one or more SBFD symbols and not in the one or more non-SBFD symbols of the target slot determined as a SBFD slot, or may be received in the one or more non-SBFD symbols and not in the one or more SBFD symbols of the target slot determined as a non-SBFD slot, based on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot.

Some examples of the method, network entities, and non-transitory computer-readable medium described herein may further include operations, features, means, or instructions for transmitting an indication of a duplex type of the one or more sounding reference signal resources of the sounding reference signal resource set, where receiving the quantity of sounding reference signals in the target slot includes receiving sounding reference signaling via one or more symbols, of the sounding reference signal resource set, in the target slot, where the sounding reference signaling may be transmitted in the one or more SBFD symbols and in the one or more non-SBFD symbols.

### BRIEF DESCRIPTION OF THE DRAWINGS

FIG. 1 shows an example of a wireless communications system that supports sounding reference signal (SRS) slot schedules for slots with mixed sub-band full-duplex (SBFD) and non-sub-band full-duplex (non-SBFD) symbols in accordance with one or more aspects of the present disclosure.

FIG. 2 shows an example of a wireless communications system that supports SRS slot schedules for slots with mixed SBFD and non-SBFD symbols in accordance with one or more aspects of the present disclosure.

FIG. 3 shows an example of a slot structure 300 that supports SRS slot schedules for slots with mixed SBFD and non-SBFD symbols in accordance with one or more aspects of the present disclosure.

FIG. 4 shows an example of a slot structure 400 that supports SRS slot schedules for slots with mixed SBFD and non-SBFD symbols in accordance with one or more aspects of the present disclosure.

FIG. 5 shows an example of a process flow that supports SRS slot schedules for slots with mixed SBFD and non-SBFD symbols in accordance with one or more aspects of the present disclosure.

FIGS. 6 and 7 show block diagrams of devices that support SRS slot schedules for slots with mixed SBFD and non-SBFD symbols in accordance with one or more aspects of the present disclosure.

FIG. 8 shows a block diagram of a communications manager that supports SRS slot schedules for slots with mixed SBFD and non-SBFD symbols in accordance with one or more aspects of the present disclosure.

FIG. 9 shows a diagram of a system including a device that supports SRS slot schedules for slots with mixed SBFD and non-SBFD symbols in accordance with one or more aspects of the present disclosure.

FIGS. 10 and 11 show block diagrams of devices that support SRS slot schedules for slots with mixed SBFD and non-SBFD symbols in accordance with one or more aspects of the present disclosure.

FIG. 12 shows a block diagram of a communications manager that supports SRS slot schedules for slots with mixed SBFD and non-SBFD symbols in accordance with one or more aspects of the present disclosure.

FIG. 13 shows a diagram of a system including a device that supports SRS slot schedules for slots with mixed SBFD and non-SBFD symbols in accordance with one or more aspects of the present disclosure.

FIGS. 14 through 17 show flowcharts illustrating methods that support SRS slot schedules for slots with mixed SBFD and non-SBFD symbols in accordance with one or more aspects of the present disclosure.

### DETAILED DESCRIPTION

In some wireless communication systems, a user equipment (UE) may transmit a sounding reference signal (SRS) to a network entity. Examples of SRS signals may include aperiodic SRS (A-SRS), periodic SRS, and semi-persistently scheduled SRS. The network entity may utilize the SRS to estimate one or more channel characteristics for communicating with the UE. In some examples, the UE may transmit the SRS on one or more uplink symbols in an uplink slot of a time-division duplexing (TDD) pattern. Some TDD slot structures may include one or more mixed sub-band full-duplex (SBFD) slots. A first portion of a mixed SBFD slot may include a frequency band (e.g., a sub-band) for uplink transmissions (e.g., one or more uplink symbols) and a frequency band for downlink communications (e.g., one or more downlink symbols), and a second portion of the mixed SBFD slot may dedicate frequency resources of the slot for uplink communications.

In some examples of SRS signaling, a slot for SRS transmission may be scheduled based on a triggering transmission (e.g., downlink control information (DCI)) from the network entity to the UE. In some examples, the UE may determine a target slot to transmit the SRS by counting an offset quantity of slots (e.g., physical slots or available slots) from a reference slot.

Some issues may arise when scheduling SRS in a TDD structure that includes one or more mixed SBFD slots. For instance, if a scheduled SRS resource overlaps with both SBFD and non-SBFD symbols, phase may be discontinuous between the SBFD and non-SBFD symbols, one or more communication parameters may differ between the SBFD and non-SBFD symbols, or a guard period may occur between the SBFD and non-SBFD symbols. One or more of these issues may disrupt SRS transmission or the accuracy of an SRS measurement.

Some examples of the techniques described herein may provide approaches for scheduling SRS in a TDD structure with one or more mixed SBFD slots. For SRS based on physical slot counting, for example, some of the techniques described herein may provide approaches indicating whether to transmit or drop SRS resources in SBFD or non-SBFD symbols when the slot offset from a triggering downlink control information (DCI) indicates a target slot with mixed SBFD and non-SBFD symbols. For SRS based on available slot counting, for example, some of the techniques described herein may indicate whether a target slot with mixed SBFD and non-SBFD symbols is an available slot for SRS (e.g., A-SRS) transmission. For duplex-specific SRS, for example, some of the techniques described herein may indicate whether to label or determine the target slot with mixed SBFD and non-SBFD symbols as an SBFD-specific slot or non-SBFD-specific slot, or whether a resource that maps to both SBFD and non-SBFD symbols may be sent or dropped.

Some examples of the techniques described herein may enable the transmission of SRS in mixed SBFD slots, which may increase communication structure flexibility for SRS transmission. Allowing SRS transmission in mixed SBFD slots may reduce delay for SRS transmissions, which may allow a network entity to estimate a channel more frequently, thereby improving communication reliability. Transmitting SRS in mixed SBFD slots may increase resource utilization efficiency. Some examples of the techniques described herein may include partially or completely dropping SRS transmissions in mixed SBFD slots. In some aspects, dropping SRS transmissions may reduce scheduling complexity or may allow resources of mixed SBFD slots to be utilized for other communications. Partially dropping SRS transmissions in mixed SBFD slots may allow for SRS to be partially transmitted while avoiding SRS transmissions in downlink resources, which may avoid interference with downlink transmissions.

Aspects of the disclosure are initially described in the context of wireless communications systems. Aspects of the disclosure are further illustrated by and described with reference to slot structure diagrams. Aspects of the disclosure are further illustrated by and described with reference to a process flow diagram. Aspects of the disclosure are further illustrated by and described with reference to apparatus diagrams, system diagrams, and flowcharts that relate to SRS slot schedules for slots with mixed SBFD and non-SBFD symbols.

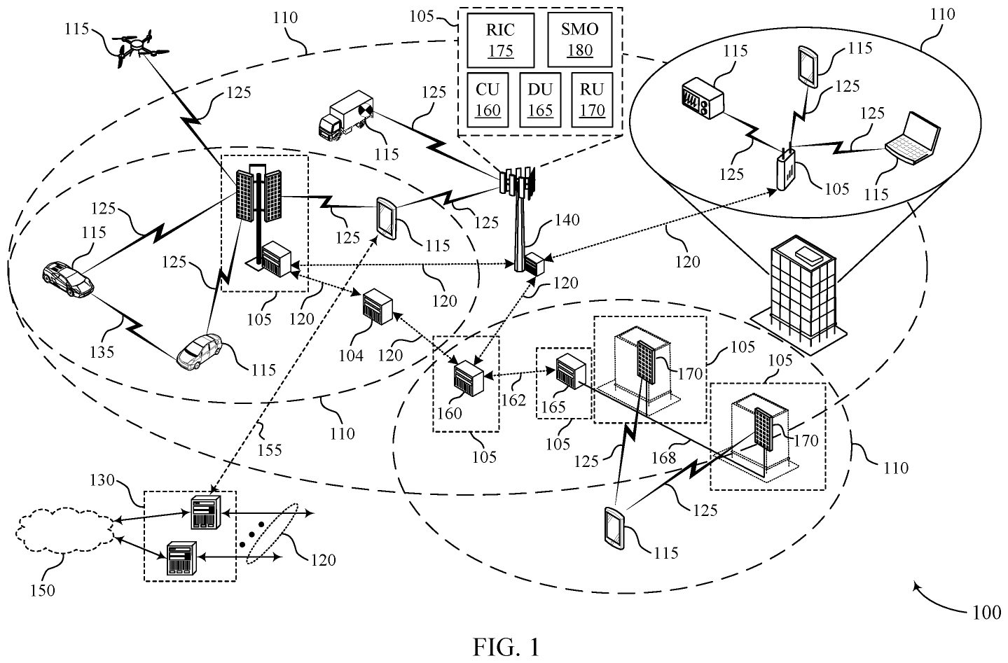

FIG. 1 shows an example of a wireless communications system 100 that supports SRS slot schedules for slots with mixed SBFD and non-SBFD symbols in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SRS slot schedules for slots with mixed SBFD and non-SBFD symbols as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the UE 115 may transmit an SRS to the network entity 105. Examples of SRS signals may include A-SRS, periodic SRS, and semi-persistently scheduled SRS. The network entity 105 may utilize the SRS to estimate one or more channel characteristics for communicating with the UE 115. In some examples, the UE 115 may transmit the SRS on one or more uplink symbols in an uplink slot of a TDD pattern. Some TDD slot structures may include one or more mixed SBFD slots. A first portion of a mixed SBFD slot may include a frequency band (e.g., a sub-band) for uplink transmissions (e.g., one or more uplink symbols) and a frequency band for downlink communications (e.g., one or more downlink symbols), and a second portion of the mixed SBFD slot may dedicate frequency resources of the slot (e.g., an entire bandwidth of the allocated resources or frequency resources without a sub-band) for uplink communications.

Allowing a slot to include SBFD and non-SBFD symbols may enable compatibility with symbol-level TDD uplink and downlink configurations. Frequent switching between SBFD and non-SBFD symbols may increase implementation complexity and interruptions of transmissions or receptions during a transition. In some approaches, a quantity of switching between SBFD and non-SBFD symbols within a slot, within a TDD uplink and downlink pattern period, or within a semi-static SBFD configuration period (if different from the TDD uplink and downlink pattern period) may be limited. For semi-static SBFD, for example, to avoid frequent switching between SBFD and non-SBFD symbols, a limited quantity of transition points between SBFD and non-SBFD symbols may be utilized. For instance, two transition points may be utilized, including one transition point from non-SBFD symbols to SBFD symbols and one transition point from SBFD symbols to non-SBFD symbols within a TDD uplink and downlink pattern period. Other quantities of transition points may be utilized or allowed in some approaches. In some examples, a transition point may be aligned with a slot boundary or may occur within a slot.

In some scenarios, a guard period between SBFD and non-SBFD symbols may be utilized or may not be utilized at the network entity 105 or at the UE 115 based on implementation of SBFD operation. If utilized, the length of the guard period may allow time for switching procedures (e.g., for transmit and receive chain switching or for transceiver tuning).

In some examples of SRS signaling, a slot for SRS transmission may be scheduled based on a triggering transmission (e.g., DCI) from the network entity 105 to the UE 115. In some examples, the UE 115 may determine a target slot to transmit the SRS by counting an offset quantity of slots (e.g., physical slots or available slots) from a reference slot. In some examples, the reference slot may be a slot that includes the triggering transmission (e.g., DCI). In some examples, the reference slot may occur after the slot that includes the triggering transmission (e.g., DCI).

Some examples of the techniques described herein may provide approaches for scheduling SRS in a TDD structure with one or more mixed SBFD slots. For SRS based on physical slot counting, for example, some of the techniques described herein may provide approaches indicating whether to transmit or drop SRS resources in SBFD or non-SBFD symbols when the slot offset from a triggering DCI indicates a target slot with mixed SBFD and non-SBFD symbols. For SRS based on available slot counting, for example, some of the techniques described herein may indicate whether a target slot with mixed SBFD and non-SBFD symbols is an available slot for SRS (e.g., A-SRS) transmission. For duplex-specific SRS, for example, some of the techniques described herein may indicate whether to label or determine the target slot with mixed SBFD and non-SBFD symbols as an SBFD-specific slot or non-SBFD-specific slot, or whether a resource that maps to both SBFD and non-SBFD symbols may be sent or dropped.

One or more of the following approaches may be utilized for an SRS that is mapped to SBFD and non-SBFD symbols in a mixed SBFD slot. In some approaches, the UE 115 may not transmit or the network entity 105 may not receive the SRS within the mixed SBFD slot. In some approaches, the UE 115 may transmit or the network entity 105 may receive the SRS within the mixed SBFD slot when one or more conditions are satisfied. For example, the conditions may be based on whether or not phase continuity is maintained across SBFD and non-SBFD symbols, whether one or more communication parameters are applied in SBFD and non-SBFD symbols (e.g., whether there are same or different transmission or reception parameters such as power control parameters, spatial or quasi-colocation (QCL) parameters, or uplink timing parameters, among other examples), or whether a guard period is located between the SBFD and non-SBFD symbols.

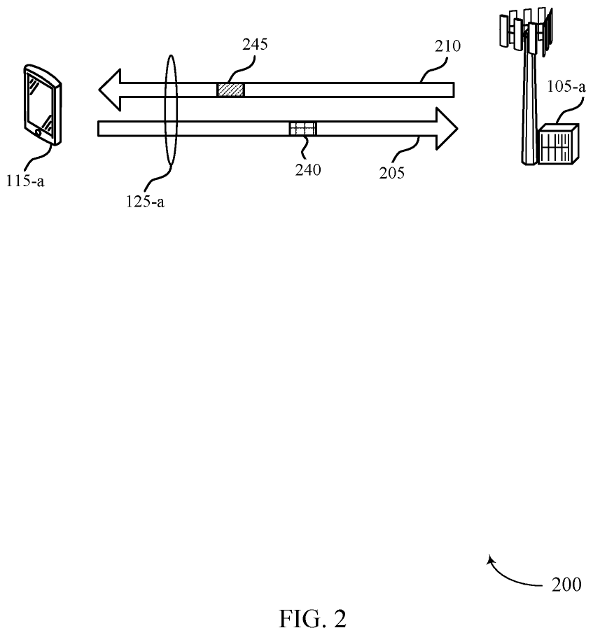

FIG. 2 shows an example of a wireless communications system 200 that supports SRS slot schedules for slots with mixed SBFD and non-SBFD symbols in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, which may be an example of a communication link 125 described with respect to FIG. 1. The communication link 125-a may include a bi-directional link that enables both uplink and downlink network communications. For example, the UE 115-a may transmit one or more uplink transmissions 205, such as uplink control signals or uplink data signals, to the network entity 105-a using the communication link 125-a, and the network entity 105-a may transmit one or more downlink transmissions 210, such as downlink control signals or downlink data signals, to the UE 115-a using the communication link 125-a.

The network entity 105-a may transmit, to the UE 115-a, a schedule 245 for an SRS resource set. An SRS resource set may include one or more resources for transmission of one or more SRSs. For example, SRS resources may include time and frequency resources (e.g., resource elements) allocated for the transmission of one or more SRSs. A schedule 245 may be information indicating timing for the SRS resource set. For instance, the schedule 245 may indicate a target slot allocated for the transmission of one or more SRSs. In some approaches, the schedule 245 may indicate a slot offset for the target slot relative to a reference slot. A reference slot may be a slot in a TDD slot structure that may be utilized to determine a target slot for SRS transmission. In some approaches (with physical slot counting, for example), the reference slot may be a slot in which a triggering transmission (e.g., DCI) is sent. With physical slot counting, each slot subsequent to the reference slot may be counted to determine the target slot. In some approaches (with available slot counting, for example), the reference slot may be a slot subsequent to a slot in which a triggering transmission (e.g., DCI) is sent. For instance, the reference slot may be a slot that is a quantity of slots after the slot with the DCI triggering an SRS transmission. The slot offset may be counted for each available slot subsequent to the reference slot. An available slot may be a slot that satisfies one or more conditions (as further described herein, for example).

The UE 115-a may transmit a quantity of SRSs 240 in the target slot. For example, the UE 115-a may transmit zero, one, or more SRSs 240 in the target slot. The quantity of transmitted SRSs 240 may be based on the target slot including one or more SBFD symbols and one or more non-SBFD symbols. For instance, the quantity of SRSs 240 transmitted in the target slot may be based on whether the target slot is a mixed SBFD slot. The quantity of transmitted SRSs 240 may be based on one or more SRS resources of the SRS resource set overlapping between the one or more SBFD symbols and the one or more non-SBFD symbols. For instance, the quantity of SRSs 240 transmitted in the target slot may be based on whether one or more of the SRS resources (e.g., a time domain resource or OFDM symbol of one of the SRS resources) overlaps between a portion of the target slot that includes one or more SBFD symbols (e.g., a portion of the target slot that includes an uplink sub-band and a downlink sub-band) and a portion of the target slot that includes one or more non-SBFD symbols (e.g., a portion of the target slot that is dedicated to uplink resources or that does not include a downlink sub-band). The network entity 105-a may receive the quantity of SRSs 240 transmitted in the target slot.

In some examples, the UE 115-a may refrain from transmitting (or the network entity 105-a may refrain from receiving) sounding reference signaling via one or more symbols of the one or more SRS resources overlapping between the one or more SBFD symbols and the one or more non-SBFD symbols. For instance, the UE 115-a may drop one or more SRSs of an SRS resource that overlaps between an SBFD symbol and a non-SBFD symbol. In some approaches, all sounding reference signaling (e.g., one or more SRSs) corresponding to one or more SRS resources that overlap between and SBFD symbol and a non-SBFD symbol may be dropped. In some approaches, sounding reference signaling may be partially dropped. For instance, one or more symbols or SRSs corresponding to one or more SRS resources that overlap between an SBFD symbol and a non-SBFD symbol may be dropped, and one or more symbols or SRSs 240 corresponding to one or more SRS resources that do not overlap between an SBFD symbol and a non-SBFD symbol may be transmitted. In some examples, one or more symbols or SRSs of one or more SRS resources corresponding to one or more SBFD symbols may be dropped and one or more symbols or SRSs 240 of one or more SRS resources corresponding to one or more non-SBFD symbols may be transmitted. In some examples, one or more symbols or SRSs of one or more SRS resources corresponding to one or more non-SBFD symbols may be dropped and one or more symbols or SRSs 240 of one or more SRS resources corresponding to one or more SBFD symbols may be transmitted. In some aspects, refraining from transmitting or receiving sounding reference signaling via one or more symbols of the one or more SRS resources overlapping between the one or more SBFD symbols and the one or more non-SBFD symbols may be performed for an A-SRS resource set based on a physical slot offset or with physical slot counting (e.g., when the UE 115-a does not support available slot counting for A-SRS).

In some approaches, the UE 115-a may refrain from transmitting (or the network entity 105-a may refrain from receiving) sounding reference signaling via the SRS resource set in response to the one or more SRS resources overlapping between the one or more SBFD symbols and the one or more non-SBFD symbols. For example, the UE 115-a or the network entity 105-a may drop sounding reference signaling of the entire SRS resource set in the target slot. In some aspects, refraining from transmitting or receiving sounding reference signaling via the SRS resource set in response to the one or more SRS resources overlapping between the one or more SBFD symbols and the one or more non-SBFD symbols may be performed for an A-SRS resource set based on a physical slot offset or with physical slot counting (e.g., when the UE 115-a does not support available slot counting for A-SRS).

In some examples, the one or more SRS resources may be restricted from overlapping between the one or more SBFD symbols and the one or more non-SBFD symbols. For instance, the UE 115-a or the network entity 105-a may refrain from scheduling, transmitting, or receiving SRS signaling for SRS resources overlapping between one or more SBFD symbols and one or more non-SBFD symbols (e.g., the UE 115-a may not expect SRS signaling to be scheduled, transmitted, or received via SRS resources overlapping between one or more SBFD symbols and one or more non-SBFD symbols). In some approaches, the UE 115-a or the network entity 105-a may take no action regarding (e.g., may not allocate, schedule, or communicate signaling on) SRS resources overlapping between one or more SBFD symbols and one or more non-SBFD symbols. In some examples, the UE 115-a or the network entity 105-a may detect an error in response to the one or more SRS resources overlapping between the one or more SBFD symbols and the one or more non-SBFD symbols. In a case that the target slot includes the one or more SRS resources overlapping between the one or more SBFD symbols and the one or more non-SBFD symbols, the UE 115-a or the network entity 105-a may detect the scheduling as an error case. The UE 115-a or the network entity 105-a may log the error or transmit an indication of the error. In some aspects, the restriction for one or more SRS resources overlapping between the one or more SBFD symbols and the one or more non-SBFD symbols may be utilized for an A-SRS resource set based on a physical slot offset or with physical slot counting (e.g., when the UE 115-a does not support available slot counting for A-SRS).

In some approaches, the UE 115-a may transmit (or the network entity 105-a may receive) sounding reference signaling via one or more symbols of the SRS resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols, or any combination thereof. The phase continuity condition may be satisfied if phase continuity is maintained across SBFD and non-SBFD symbols. The communication parameter condition may be satisfied if one or more same communication parameters are applied in SBFD and non-SBFD symbols (e.g., the same transmission or reception parameters are applied in SBFD and non-SBFD symbols, such as power control parameters, spatial or QCL parameters, or uplink timing parameters, among other examples). The guard period condition may be satisfied if a guard period is not located between the SBFD and non-SBFD symbols. In a case that one or more (e.g., all) of the conditions are satisfied, the UE 115-a or the network entity 105-a may communicate the sounding reference signaling via one or more symbols of the SRS resource set. In some cases, all sounding reference signaling in the target slot (e.g., the mixed SBFD slot) may be communicated (e.g., transmitted or received). In some aspects, communicating sounding reference signaling via one or more symbols of the SRS resource set based on the one or more conditions may be performed for an A-SRS resource set based on a physical slot offset or with physical slot counting (e.g., when the UE 115-a does not support available slot counting for A-SRS).

In some aspects, the UE 115-a may refrain from transmitting (or the network entity 105-a may refrain from receiving) sounding reference signaling via one or more symbols of the SRS resource set scheduled in one or more downlink SBFD symbols of the target slot. For example, one or more SRSs (e.g., SRS symbols) of the SRS resource set scheduled in one or more downlink SBFD symbols may be dropped. The UE 115-a may transmit (or the network entity 105-a may receive) one or more symbols of the SRS resource set scheduled in one or more uplink symbols of the target slot. For instance, one or more SRSs 240 (e.g., SRS symbols) of the SRS resource set scheduled in uplink SBFD symbols may be communicated. In some aspects, refraining from communicating sounding reference signaling via one or more symbols of the SRS resource set scheduled in one or more downlink SBFD symbols of the target slot or communicating one or more symbols of the SRS resource set scheduled in one or more uplink symbols of the target slot may be performed for an A-SRS resource set based on a physical slot offset or with physical slot counting (e.g., when the UE 115-a does not support available slot counting for A-SRS).

Some examples of the techniques described herein may perform sounding reference signaling for an SRS (e.g., A-SRS) resource set based on available slot counting. The UE 115-a may transmit (or the network entity 105-a may receive) an indication of a capability of the UE 115-a to support available slot offset scheduling. The schedule 245 indicating the slot offset may be received based on the capability of the UE 115-a to support available slot offset scheduling. The slot offset may be counted based on whether a slot satisfies one or more criteria as an available slot.

In some approaches, an available slot may be a slot including one or more uplink symbols, flexible symbols, or SBFD symbols for one or more time-domain locations for all the SRS resources in the SRS resource set. An available slot may also satisfy a UE 115-a capability for a timing condition between a triggering physical downlink control channel (PDCCH) and all the SRS resources in the SRS resource set. In some examples, from a first symbol carrying an SRS request DCI to a last symbol of the triggered SRS resource set, the UE 115-a may not receive a slot format indication (SFI), an uplink cancellation indication, or dynamic scheduling of a downlink channel or signal(s) on flexible symbol(s) to change the determination of an available slot. In some aspects, the UE 115-a or the network entity 105-a may determine whether a slot is an available slot based on an RRC configuration of the time resources of the SRS resources in the SRS resource set or based on the TDD pattern.

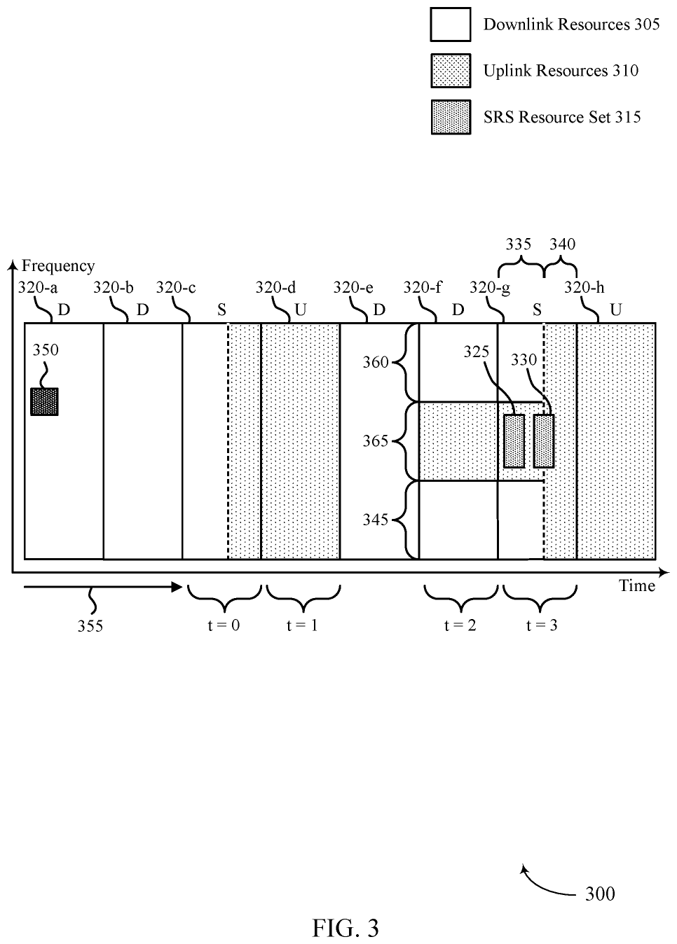

In some examples, for SRS (e.g., A-SRS) resource sets triggered by DCI, the target slot may be determined based on whether one or more slots are available slots and based on a DCI indication (e.g., a DCI codepoint) of the slot offset from a set of slot offsets per SRS set. For instance, each SRS resource set may be configured with a value (e.g., a “t-value”) up to a maximum quantity (e.g., 4) of available slots. The DCI may include a configurable bitfield (which may be referred to as a DCI codepoint). For example, the bitfield in the DCI may include up to 2 bits, which may indicate one the values (e.g., “t-values”). The value may be indicated via DCI if more than one value is indicated or the value may be indicated via an RRC signal (if one value is configured in the RRC signal, for instance) from the network entity 105-a to the UE 115-a. In some aspects, DCI codepoints bits of 00, 01, 10, and 11 may respectively indicate slot offsets of 0, 1, 2, and 3 available slots. The bits may correspond to different slots in some examples (where the slot offset values may include a value of 0, for instance). An example of target slot determination based on a slot offset and available slots is given with reference to FIG. 3.

One or more approaches may be utilized for an aperiodic SRS resource set based on a slot offset of available slots (when the UE 115-a supports available slot counting for A-SRS, for example) if the target slot has mixed SBFD and non-SBFD symbols and if the time domain resource (e.g., OFDM symbols) of one of the SRS resources overlaps with SBFD and non-SBFD symbols. In some approaches, a slot may be unavailable if the slot is a mixed SFBD slot and one or more of the SRS resources overlaps between an SBFD symbol and a non-SBFD symbol. For example, the UE 115-a may determine that the slot is unavailable based on (e.g., in response to) the one or more SRS resources overlapping between an SBFD symbol and a non-SBFD symbol. SRS communication for one or more SRS resources may be postponed until a subsequent available slot (e.g., a next available slot). For example, the UE 115-a may refrain from transmitting (or the network entity 105-a may refrain from receiving) sounding reference signaling via the SRS resource set in the target slot, where the target slot is unavailable based on the one or more SRS resources overlapping between the one or more SBFD symbols and the one or more non-SBFD symbols. The UE 115-a may transmit (or the network entity 105-a may receive) the sounding reference signaling in an available slot (e.g., a next available slot) after the target slot.

In some approaches, a mixed SBFD slot may be an available slot. For example, the UE 115-a may transmit (or the network entity 105-a may receive) sounding reference signaling, of the SRS resource set, scheduled in the target slot, where the target slot may be available based on the target slot including the one or more SBFD symbols. For instance, the UE 115-a may determine the target slot as being available, and may then transmit the sounding reference signaling. In some examples, the sounding reference signaling may be transmitted (or received) if the sounding reference signaling is included (e.g., contained) in an uplink subband. Slot availability may be determined based on time-domain resources including SBFD symbols. Whether the SRS resource is communicated or dropped may depend on frequency resources of the SRS resource (e.g., if an SRS symbol is scheduled in a downlink frequency resource) or one or more other conditions (e.g., a phase continuity condition, a communication parameter condition, a guard period condition, or any combination thereof). For example, the UE 115-a may refrain from transmitting (or the network entity 105-a may refrain from receiving) sounding reference signaling via one or more downlink symbols, of the SRS resource set, scheduled in the target slot.

In some examples, slot availability may be determined (by the UE 115-a or the network entity 105-a) based on time and frequency conditions of the SRS resources. For instance, the UE 115-a may transmit (or the network entity 105-a may receive) sounding reference signaling via one or more symbols of the SRS resource set in the target slot, where the target slot is available based on the SRS resource set not overlapping with one or more downlink resources in the target slot. Additionally, or alternatively, the UE 115-a may refrain from transmitting (or the network entity 105-a may refrain from receiving) sounding reference signaling via the SRS resource set in the target slot, where the target slot is unavailable based on the SRS resource set overlapping with one or more downlink resources in the target slot. For example, the UE 115-a may determine that the slot is unavailable based on (e.g., in response to) the one or more SRS resources overlapping between an SBFD symbol and a non-SBFD symbol.

In some approaches, SRS resources (e.g., SRS frequency resources or an SRS spatial filter) may be shared for SBFD symbols and non-SBFD symbols. For example, a same SRS resource set may have different parameters for SBFD symbols and non-SBFD symbols.

In some approaches, SRS resources (e.g., for periodic SRS, semi-persistent SRS, or aperiodic SRS with available slot counting) may be configured as duplex-specific SRS resources. For example, SRS resources (e.g., an SRS resource set) may be configured with a duplex type as SBFD SRS resources or non-SBFD resources. Duplex-specific SRS resources may be utilized to address some differences in communicating SBFD and non-SBFD symbols.

Uplink reception for SBFD symbols may differ from non-SBFD symbols (e.g., TDD symbols without sub-bands) in one or more aspects. For example, SBFD symbols may exhibit a different link quality due to residual interference in addition to inter-network entity interference. In some cases, a network entity may have a different receive combiner or a different receive beam (due to a direction being jammed by interference or cross-link interference (CLI), for instance). Uplink frequency resources may be different in an uplink sub-band, as a sub-band may have limited resources relative to the frequency resources of an uplink band (e.g., a full bandwidth in a slot). In some cases, the UE 115-a may have a different transmission power or per-resource block power for SBFD symbols relative to non-SBFD symbols. In some approaches, a receive (e.g., uplink) antenna panel may differ between SBFD slots and non-SBFD slots. Port-to-antenna element virtualization may also be different to utilize a baseband transceiver unit efficiently.

In an example, a network entity may have two antenna panel sets, where a first panel set may include a first panel for transmission and a second panel for reception, and where a second panel set may include a third panel for reception and a fourth panel for reception. The first panel set may be dedicated to SBFD reception on the second panel, where a first SRS resource and a second SRS resource may be received using two ports. The second panel set may be dedicated to non-SBFD reception on the third and fourth panels, where a third SRS resource, a fourth SRS resource, and a fifth SRS resource may be received using four ports. In this example, the first SRS resource is specific to SBFD duplexing (e.g., has an SBFD duplex type) and the third SRS resource is specific to non-SBFD duplexing (e.g., has a non-SBFD duplex type). For an SBFD-specific SRS resource, a frequency hopping pattern and perfect forwarding secrecy (PFS) pattern may be configured by the network entity 105-a to map to (e.g., within) frequency resources of the uplink sub-band.

In a case that an SRS resource with an SBFD duplex type is scheduled to a non-SBFD slot (e.g., a TDD slot without sub-bands), sounding reference signaling in the non-SBFD slot may be dropped. For instance, the first SRS resource may be configured to transmit with a two-slot periodicity. In cases where the first SRS resource is scheduled in a non-SBFD slot, the sounding reference signaling of the first SRS resource may be dropped. In cases where the first SRS resource is scheduled in a SBFD slot, the sounding reference signaling of the first SRS resource may be transmitted.

In a case that an SRS resource with a non-SBFD duplex type is scheduled to a SBFD slot (e.g., a TDD slot with sub-bands), sounding reference signaling in the SBFD slot may be dropped. For instance, the third SRS resource (with half duplex, for example) may be configured to transmit with a five-slot periodicity. In cases where the third SRS resource is scheduled in an SBFD slot, the sounding reference signaling of the third SRS resource may be dropped. In cases where the third SRS resource is scheduled in a non-SBFD slot, the sounding reference signaling of the third SRS resource may be dropped.

Some examples of the techniques described herein may address situations where SRS resources with a duplex type (e.g., an SBFD duplex type or a non-SBFD duplex type) are scheduled in a mixed SBFD slot. For instance, one or more of the approaches described herein may be utilized for an SRS resource configured with an SBFD duplex type (e.g., SBFD-only duplex type) that occurs in a slot with SBFD and non-SBFD symbols, where the time locations of the SRS resource maps to both SBFD symbols (e.g., SBFD-only symbols) and non-SBFD symbols (e.g., non-SBFD-only symbols). Some of the described approaches may be applied for one or more SRS hops of an SRS resource that occurs across SBFD and non-SBFD symbols.

In some approaches, sounding reference signaling may be partially dropped in OFDM symbols with a non-matching (e.g., opposite) duplex type. For example, the network entity 105-a may transmit (or the UE 115-a may receive) an indication of a duplex type of the one or more SRS resources of the SRS resource set. The UE 115-a may refrain from transmitting sounding reference signaling via one or more symbols, of the SRS resource set, scheduled in a resource of the target slot that does not match the duplex type. Additionally, or alternatively, the network entity 105-a may transmit (or the UE 115-a may receive) an indication of a duplex type of the one or more SRS resources of the SRS resource set. The UE 115-a may transmit (or the network entity 105-a may receive) sounding reference signaling via one or more symbols, of the SRS resource set, scheduled in a resource of the target slot that matches the duplex type. In some examples, one or more SRSs of one or more SRS resources with a non-SBFD duplex type that are scheduled to one or more symbols with an SBFD duplex type may be dropped and one or more SRSs 240 of one or more SRS resources with a non-SBFD duplex type that are scheduled to one or more symbols with a non-SBFD duplex type may be transmitted. In some examples, one or more SRSs of one or more SRS resources with an SBFD duplex type that are scheduled to one or more symbols with a non-SBFD duplex type may be dropped and one or more SRSs 240 of one or more SRS resources with an SBFD duplex type that are scheduled to one or more symbols with an SBFD duplex type may be transmitted.

In some approaches, sounding reference signaling may be dropped (e.g., completely dropped) in OFDM symbols with both duplex types. For example, the network entity 105-a may transmit (or the UE 115-a may receive) an indication of a duplex type of the one or more SRS resources of the SRS resource set. The UE 115-a may refrain from transmitting (or the network entity 105-a may refrain from receiving) sounding reference signaling via the one or more SRS resources overlapping between the one or more SBFD symbols and the one or more non-SBFD symbols.

In some approaches, the sounding reference signaling may be communicated (e.g., not dropped) if one or more conditions are satisfied (and configured transmit parameters are used, for instance). The network entity 105-a may transmit (or the UE 115-a may receive) an indication of a duplex type of the one or more SRS resources of the SRS resource set. The UE 115-a may transmit (or the network entity 105-a may receive) sounding reference signaling via one or more symbols, of the SRS resource set, based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols, or any combination thereof. The phase continuity condition, the communication parameter condition, or the guard period condition may be satisfied as described herein. For instance, the sounding reference signaling may be communicated in the target slot if the phase continuity condition, the communication parameter condition, or the guard period condition are satisfied.

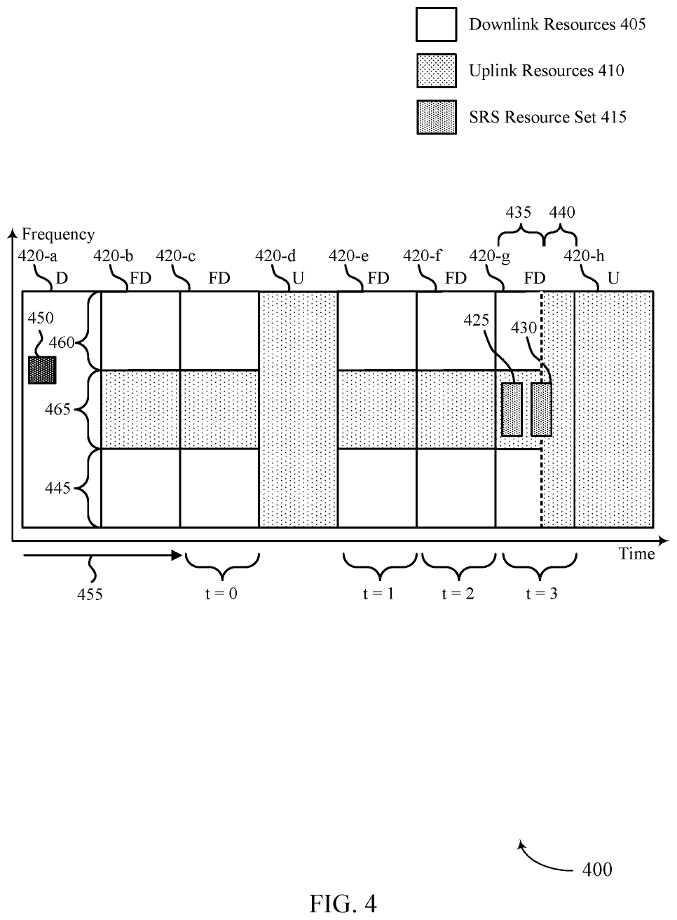

In some approaches where the UE 115-a supports available slot counting (e.g., where the slot offset is counted based on available slots), available slots with same duplex type may be counted based on the duplex-type of the triggered SRS set. Some examples of the techniques described herein may provide SRS communication based on whether a mixed SBFD slot (e.g., a slot with SBFD and non-SBFD symbols) qualifies as an SBFD slot or a non-SBFD slot. For instance, a slot may quality as an SBFD slot when all SRS resources of the triggered SRS resource set occur in the SBFD symbols. Alternatively, a slot may quality as a non-SBFD slot when all SRS resources of the triggered SRS resource set occur in the non-SBFD symbols. An example of available slot counting in the context of duplex types is given with reference to FIG. 4.

One or more approaches may be utilized when the time-domain resource (OFDM symbols) of the SRS resources occur in both SBFD and non-SBFD symbols in the slot. In some approaches, the network entity 105-a may transmit (or the UE 115-a may receive) an indication of a duplex type of the one or more SRS resources of the SRS resource set. The UE 115-a may refrain from transmitting (or the network entity 105-a may refrain from receiving) sounding reference signaling via the SRS resource set in the target slot, where the target slot is unavailable in response to the one or more SRS resources overlapping between the one or more SBFD symbols and the one or more non-SBFD symbols. For example, the UE 115-a may determine that the slot is unavailable based on (e.g., in response to) the one or more SRS resources overlapping between an SBFD symbol and a non-SBFD symbol.

In some approaches, a slot may be available and labeled as an SBFD slot (e.g., SBFD-only slot). SRS resources of the SRS resource set in the SBFD symbols may be transmitted. Alternatively, a slot may be available and labeled as a non-SBFD slot (e.g., non-SBFD-only slot). SRS resources of the SRS resource set in the non-SBFD symbols may be transmitted. For instance, the network entity 105-a may transmit (or the UE 115-a may receive) an indication of a duplex type of the one or more SRS resources of the SRS resource set. The UE 115-a may transmit (or the network entity 105-a may receive) sounding reference signaling via one or more symbols, of the SRS resource set, in the target slot, where the sounding reference signaling is communicated in the one or more SBFD symbols and not in the one or more non-SBFD symbols, or where the sounding reference signaling is communicated in the one or more non-SBFD symbols and not in the one or more SBFD symbols. For example, the UE 115-a (or the network entity 105-a) may determine the target slot as an SBFD slot and may transmit (or receive) sounding reference signaling in the one or more SBFD symbols and not in the one or more non-SBFD symbols. Alternatively, the UE 115-a (or the network entity 105-a) may determine the target slot as a non-SBFD slot and may transmit (or receive) sounding reference signaling in the one or more non-SBFD symbols and not in the one or more SBFD symbols.

In some examples, the sounding reference signaling may be communicated in the one or more SBFD symbols and not in the one or more non-SBFD symbols (of the target slot being determined as an SBFD slot, for instance) or may be communicated in the one or more non-SBFD symbols and not in the one or more SBFD symbols (of the target slot being determined as a non-SBFD slot, for instance) based on a quantity or location of SBFD symbols in the target slot. In some approaches, communicating the sounding reference signaling may be based on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot. For instance, determination as an SBFD slot (e.g., SBFD-only slot) may be based on a rule. One example of the rule may be based on a quantity of SRS resources in the SBFD portion of the slot being greater than a quantity of SRS resources in the non-SBFD portion of the slot. Another example of the rule may be based on a quantity of SRS OFDM symbols in the SBFD portion of the slot being greater than a quantity of SRS OFDM symbols in the non-SBFD portion of the slot. Yet another example of the rule may be based on whether the slot begins with an SBFD symbol.

In some approaches, all SRS resources in the SRS resource set may be communicated (e.g., transmitted or received). The network entity 105-a may transmit (or the UE 115-a may receive) an indication of a duplex type of the one or more SRS resources of the SRS resource set. The UE 115-a may transmit (or the network entity 105-a may receive) sounding reference signaling via one or more symbols, of the SRS resource set, in the target slot, where the sounding reference signaling is communicated in the one or more SBFD symbols and in the one or more non-SBFD symbols.

FIG. 3 shows an example of a slot structure 300 that supports SRS slot schedules for slots with mixed SBFD and non-SBFD symbols in accordance with one or more aspects of the present disclosure. The wireless communications system 100 or the wireless communications system 200 may operate in accordance with one or more aspects of the slot structure 300 in some approaches. The slot structure 300 is illustrated in time and frequency dimensions.

In the example of FIG. 3, the slot structure 300 includes eight slots: a first slot 320-a, a second slot 320-b, a third slot 320-c, a fourth slot 320-d, a fifth slot 320-c, a sixth slot 320-f, a seventh slot 320-g, and an eighth slot 320-h. Downlink slots are denoted with a “D,” uplink slots are denoted with a “U,” and special slots are denoted with an “S.” Downlink slots (e.g., the first slot 320-a, second slot 320-b, fifth slot 320-c, and sixth slot 320-f) include downlink resources 305 (e.g., resources allocated for downlink communication). Uplink slots (e.g., the fourth slot 320-d and eighth slot 320-h) include uplink resources 310 (e.g., resources allocated for uplink communication). Special slots (e.g., the third slot 320-c and seventh slot 320-g) may include a combination of downlink resources 305 and uplink resources 310 with a transition between resource types in the time domain. In some examples, a guard period may be included in a time domain transition between one or more of the downlink resources 305 and uplink resources 310.

In the example of FIG. 3, the sixth slot 320-f is a downlink slot that is also an SBFD slot. The sixth slot 320-f includes a portion of a first downlink sub-band 360, an uplink sub-band 365, and a second downlink sub-band 345. The sixth slot 320-f allows SBFD operation by providing sub-bands for concurrent uplink and downlink communication.

In the example of FIG. 3, the seventh slot 320-g is a special slot that is also a mixed SBFD slot. As illustrated in FIG. 3, a first portion 335 of the seventh slot 320-g includes a portion of the first downlink sub-band 360, the uplink sub-band 365, and the second downlink sub-band 345. A second portion 340 of the seventh slot 320-g includes uplink resources (across the bandwidth of the seventh slot 320-g, for instance) and does not include sub-bands. In some examples, a guard period (not shown in FIG. 3) may be situated between the first portion 335 and the second portion 340.

An SRS resource set 315 is scheduled in the seventh slot 320-g using available slot scheduling in the example of FIG. 3. For instance, the first slot 320-a includes DCI 350 triggering an SRS transmission. In this example, the third slot 320-c is a reference slot. In available slot counting, a reference slot may be a quantity of slots 355 from the slot including the DCI 350. As described herein, a DCI 350 may indicate an offset from a reference slot to a target slot. For instance, a DCI codepoint may indicate bits ‘11,’ which may correspond to an available slot value, t-value, of 3. In available slot counting, the target slot may be determined as a quantity of available slots from the reference slot. In the example of FIG. 3, the third slot 320-c, the fourth slot 320-d, the sixth slot 320-f, the seventh slot 320-g, and the eighth slot 320-h qualify as available slots due to including uplink resources 310. The fifth slot 320-e is an unavailable slot due to lacking uplink resources 310. With the offset of available slots from the reference slot, which omits the fifth slot 320-e, the target slot is the seventh slot 320-g in FIG. 3. In some approaches (not shown in FIG. 3), the seventh slot 320-g (e.g., a mixed SBFD slot) may instead be unavailable and sounding reference signaling of SRS resources may be dropped or postponed. Physical offset counting (not shown in FIG. 3) may include counting physical slots (regardless of type) from a slot including a triggering DCI (which may be a reference slot) in some approaches.

The SRS resource set 315 in the seventh slot 320-g includes a first SRS resource 325 and a second SRS resource 330. The second SRS resource 330 overlaps between one or more SBFD symbols in the first portion 335 and one or more non-SBFD uplink symbols in the second portion 340. In accordance with the description with reference to FIG. 2, one or more approaches may be utilized to determine whether to communicate sounding resource signaling in the SRS resource set 315. In some approaches, a UE (e.g., UE 115-a) may determine that a mixed SBFD slot (e.g., the seventh slot 320-g) is an unavailable (e.g., not available) slot and may not count the slot. In some approaches, the UE may determine a mixed SBFD slot (e.g., the seventh slot 320-g) as an available slot based on available time resources for the SRS resources within an SRS resource set (e.g., SRS resource set 315). In some approaches, the UE may determine the mixed SBFD slot (e.g., the seventh slot 320-g) as an available slot based on both available time and frequency resources for the SRS transmission. In some approaches, the sounding reference signaling corresponding to the second SRS resource 330 may be dropped. In some approaches, the entire SRS resource set 315 may be dropped. In some approaches, the sounding reference signaling corresponding to the second SRS resource 330 may be partially dropped. For instance, a portion of the second SRS resource 330 in SBFD symbols (e.g., in the first portion 335) may be dropped and a portion of the second SRS resource 330 in non-SBFD symbols (e.g., in the second portion 340) may be transmitted. Alternatively, a portion of the second SRS resource 330 in SBFD symbols (e.g., in the first portion 335) may be transmitted and a portion of the second SRS resource 330 in non-SBFD symbols (e.g., in the second portion 340) may be dropped. In some cases, a portion (not shown in FIG. 3) of an SRS resource overlapping with downlink resources may be dropped. In another approach, a portion or all of the second SRS resource 330 may be transmitted if one or more conditions are satisfied. While FIG. 3 provides an example of a slot structure 300 in accordance with some of the techniques described herein, other slot structures may be utilized in other examples in accordance with some of the techniques described herein.

FIG. 4 shows an example of a slot structure 400 that supports SRS slot schedules for slots with mixed SBFD and non-SBFD symbols in accordance with one or more aspects of the present disclosure. The wireless communications system 100 or the wireless communications system 200 may operate in accordance with one or more aspects of the slot structure 400 in some approaches. The slot structure 400 is illustrated in time and frequency dimensions.

In the example of FIG. 4, the slot structure 400 includes eight slots: a first slot 420-a, a second slot 420-b, a third slot 420-c, a fourth slot 420-d, a fifth slot 420-c, a sixth slot 420-f, a seventh slot 420-g, and an eighth slot 420-h. Downlink slots (e.g., non-SBFD downlink slots) are denoted with a “D,” uplink slots (e.g., non-SBFD uplink slots) are denoted with a “U,” and SBFD slots are denoted with an “FD.” The downlink slot (e.g., the first slot 420-a) includes downlink resources 405 (e.g., resources allocated for downlink communication). Uplink slots (e.g., the fourth slot 420-d and eighth slot 420-h) include uplink resources 410 (e.g., resources allocated for uplink communication). SBFD slots (e.g., the second slot 420-b, third slot 420-c, fifth slot 420-e, sixth slot 420-f, and seventh slot 420-g) may include a combination of downlink resources 405 and uplink resources 410. Each of the SBFD slots includes a portion of a first downlink sub-band 460, an uplink sub-band 465, and a second downlink sub-band 445. The SBFD slots allow SBFD operation by providing sub-bands for concurrent uplink and downlink communication. In some examples, a guard period may be included in a time domain transition between one or more of the downlink resources 405 and uplink resources 410.

In the example of FIG. 4, the seventh slot 420-g is a mixed SBFD slot. As illustrated in FIG. 4, a first portion 435 of the seventh slot 420-g includes a portion of the first downlink sub-band 460, the uplink sub-band 465, and the second downlink sub-band 445. The first portion 435 may have an SBFD duplex type. A second portion 440 of the seventh slot 420-g includes uplink resources (across the bandwidth of the seventh slot 420-g, for instance) and does not include sub-bands. The second portion 440 may have a non-SBFD duplex type. In some examples, a guard period (not shown in FIG. 4) may be situated between the first portion 435 and the second portion 440.

A duplex-specific SRS resource set 415 is scheduled in the seventh slot 420-g using available slot scheduling in the example of FIG. 4. For instance, the first slot 420-a includes DCI 450 triggering an SRS transmission. In this example, the third slot 420-c is a reference slot. In this examples of available slot counting, a reference slot may be a quantity of slots 455 from the slot including the DCI 450. As described herein, a DCI 450 may indicate an offset from a reference slot to a target slot. For instance, a DCI codepoint may indicate bits ‘11,’ which may correspond to a t-value of 4. In available slot counting with duplex-specific SRS resources, the target slot may be determined as a quantity of available slots from the reference slot, where an available slot may be a slot with a slot with a duplex type that matches a duplex type of SRS resources. In the example of FIG. 4, the third slot 420-c, the fifth slot 420-e, the sixth slot 420-f, and the seventh slot 420-g qualify as available slots due to having a duplex type matching the duplex type (e.g., SBFD) of the SRS resource set 415. The fourth slot 420-d is an unavailable slot (e.g., determined as unavailable) due to having a duplex type (e.g., non-SBFD) that does not match a duplex type of the SRS resource set 415. With the offset of available slots from the reference slot, which omits the fourth slot 420-d, the target slot is the seventh slot 420-g in FIG. 4. Available slot offset counting for non-SBFD SRS resources (not shown in FIG. 4) may include counting each non-SBFD slot from a reference slot in some approaches. For instance, the fourth slot 420-d and the eighth slot 420-h would be counted for scheduling of SRS resources with a non-SBFD duplex type in a non-SBFD scenario. In some examples, the fourth slot 420-d may be counted for scheduling of SRS resources with a non-SBFD duplex type.

The SRS resource set 415 in the seventh slot 420-g includes a first SRS resource 425 and a second SRS resource 430. The second SRS resource 430 overlaps between one or more SBFD symbols in the first portion 435 and one or more non-SBFD symbols in the second portion 440. In accordance with the description with reference to FIG. 2, one or more approaches may be utilized to determine whether to communicate sounding resource signaling in the SRS resource set 415. In some approaches, a UE (e.g., UE 115-a) may determine a mixed SBFD slot (e.g., the seventh slot 420-g) as an SBFD slot or as a non-SBFD slot based on whether all SRS resources occur in SBFD time resources or non-SBFD time resources, respectively. In some scenarios, the UE may determine a mixed SBFD slot (e.g., the seventh slot 420-g) as an SBFD (or non-SBFD) slot when a quantity of SRS resources in SBFD symbols are more (or less) than a quantity of SRS resources in non-SBFD symbols. In some scenarios, the UE may determine a mixed SBFD slot (e.g., the seventh slot 420-g) as an SBFD slot when a quantity of SRS symbols in SBFD is larger than a quantity of SRS symbols in the non-SBFD symbols. In some approaches, the sounding reference signaling corresponding to the second SRS resource 430 may be dropped. In some approaches, the entire SRS resource set 415 may be dropped. In some approaches, the sounding reference signaling corresponding to the second SRS resource 430 may be partially dropped. For instance, a portion of the second SRS resource 430 in the first portion 435 may be dropped and a portion of the second SRS resource 430 in the second portion 440 may be transmitted. Alternatively, a portion of the second SRS resource 430 in the first portion 435 may be transmitted and a portion of the second SRS resource 430 in the second portion 440 may be dropped. In some approaches (not shown in FIG. 4), the seventh slot 420-g may instead be unavailable (e.g., determined or indicated as unavailable) and sounding reference signaling of SRS resources may be dropped or postponed. In some cases, a portion (not shown in FIG. 4) of an SRS resource overlapping with resources of a non-matching duplex type may be dropped. In another approach, a portion or all of the second SRS resource 430 may be transmitted if one or more conditions or a rule are satisfied. While FIG. 4 provides an example of a slot structure 400 in accordance with some of the techniques described herein, other slot structures may be utilized in other examples in accordance with some of the techniques described herein.

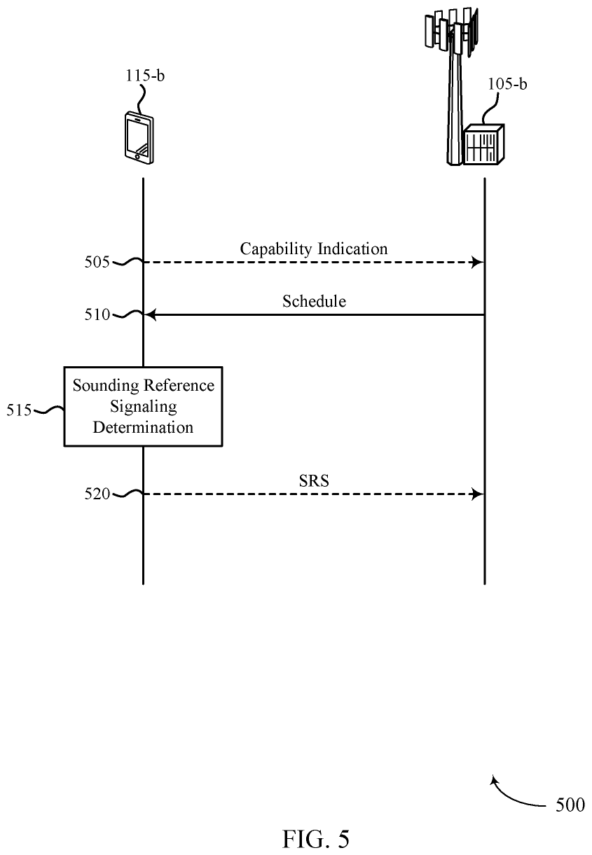

FIG. 5 shows an example of a process flow 500 that supports SRS slot schedules for slots with mixed SBFD and non-SBFD symbols in accordance with one or more aspects of the present disclosure. A wireless communication system may include a UE 115-b and a network entity 105-b. The UE 115-b may be an example of the UEs 115 or the UE 115-a, and the network entity 105-b may be an example of the network entities 105 or the network entity 105-a, as described herein.

In the following description of the process flow 500, the communications between the network entity 105-b and the UE 115-b may be transmitted in a different order than the example order shown, or the operations performed by the network entity 105-b and the UE 115-b may be performed in different orders or at different times. Some operations may be omitted from the process flow 500, and other operations may be added to the process flow 500. Further, although some operations or signaling may be shown to occur at different times for discussion purposes, these operations may actually occur at the same time or in overlapping time periods in some examples.

At 505, the UE 115-b may transmit an indication of a capability of the UE 115-b to support available slot offset scheduling to the network entity 105-b. For example, the UE 115-b may transmit information indicating a capability of the UE 115-b to support determining a target slot based on available slot offset scheduling as described with reference to FIG. 2.

At 510, the network entity 105-b may transmit a schedule to the UE 115-b. For example, the network entity 105-b may transmit information indicating a slot offset for a target slot relative to a reference slot as described with reference to FIG. 2. In some examples, the schedule may be transmitted in DCI or in another signal or message.

At 515, the UE 115-b may perform a sounding reference signaling determination. For example, the UE 115-b may determine a target slot (using physical offset counting, available slot offset counting, or available slot offset counting with duplex type, for instance). The UE 115-b may determine whether to transmit sounding reference signaling based on a mixed SBFD slot, based on an SRS resource overlapping between an SBFD symbol and a non-SBFD symbol, based on one or more conditions, or based on a duplex type of an SRS resource and a duplex type of the target slot, as described with reference to FIG. 2.

At 520, the UE 115-b may transmit a quantity of SRS. For example, network entity 105-b may transmit a quantity of SRS in a target slot in accordance with the sounding reference signaling determination as described with reference to FIG. 2. In some examples, the network entity 105-b may utilize a transmitted SRS to estimate channel characteristics for one or more communications between the network entity 105-b and the UE 115-b. For instance, the network entity 105-b may adjust signal power, phase, beamforming, channel coding, or another aspect for communicating with the UE 115-b based on the SRS.

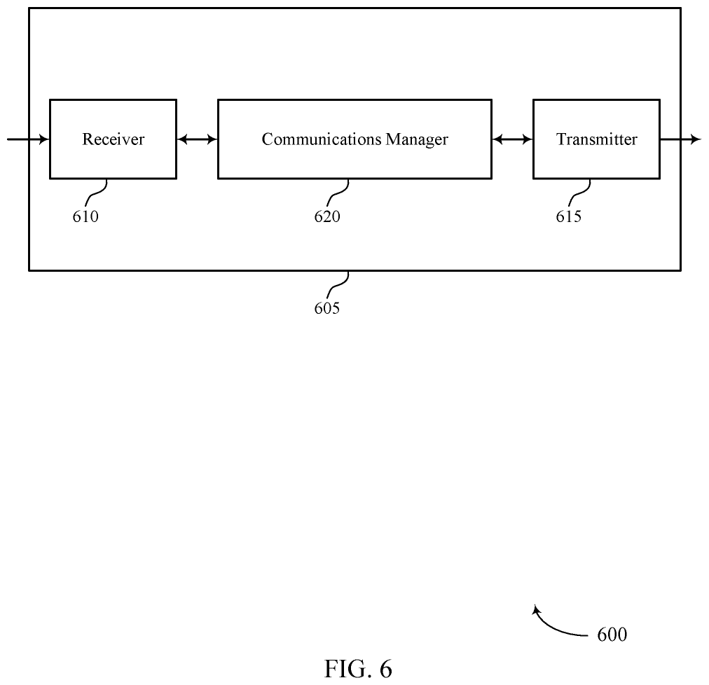

FIG. 6 shows a block diagram 600 of a device 605 that supports SRS slot schedules for slots with mixed SBFD and non-SBFD symbols in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses). Components within a wireless communication system may be coupled (for example, operatively, communicatively, functionally, electronically, and/or electrically) to each other.

The receiver 610 may provide a means for receiving information such as packets, user data, control information, or any combination thereof associated with various information channels (e.g., control channels, data channels, information channels related to SRS slot schedules for slots with mixed SBFD and non-SBFD symbols). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SRS slot schedules for slots with mixed SBFD and non-SBFD symbols). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of SRS slot schedules for slots with mixed SBFD and non-SBFD symbols as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor. If implemented in code executed by at least one processor, the functions of the communications manager 620, the receiver 610, the transmitter 615, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving a schedule for a SRS resource set, the schedule indicating a slot offset for a target slot relative to a reference slot. The communications manager 620 is capable of, configured to, or operable to support a means for transmitting a quantity of SRSs in the target slot, the quantity of transmitted SRSs being based on the target slot including one or more SBFD symbols and one or more non-SBFD symbols and being further based on one or more SRS resources of the SRS resource set overlapping between the one or more SBFD symbols and the one or more non-SBFD symbols.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources).

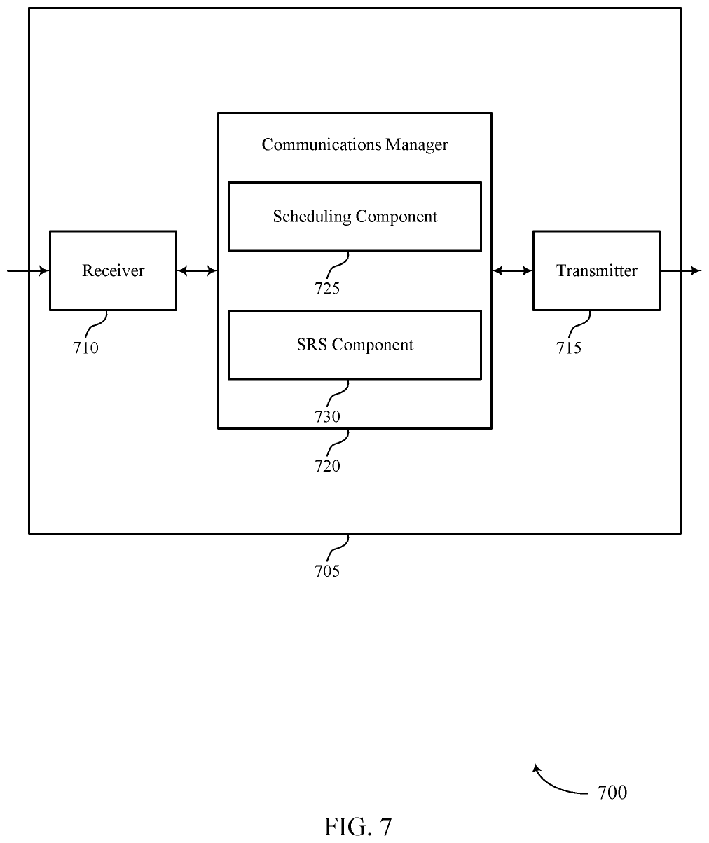

FIG. 7 shows a block diagram 700 of a device 705 that supports SRS slot schedules for slots with mixed SBFD and non-SBFD symbols in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to SRS slot schedules for slots with mixed SBFD and non-SBFD symbols). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SRS slot schedules for slots with mixed SBFD and non-SBFD symbols). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of SRS slot schedules for slots with mixed SBFD and non-SBFD symbols as described herein. For example, the communications manager 720 may include a scheduling component 725 an SRS component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The scheduling component 725 is capable of, configured to, or operable to support a means for receiving a schedule for a SRS resource set, the schedule indicating a slot offset for a target slot relative to a reference slot. The SRS component 730 is capable of, configured to, or operable to support a means for transmitting a quantity of SRSs in the target slot, the quantity of transmitted SRSs being based on the target slot including one or more SBFD symbols and one or more non-SBFD symbols and being further based on one or more SRS resources of the SRS resource set overlapping between the one or more SBFD symbols and the one or more non-SBFD symbols.

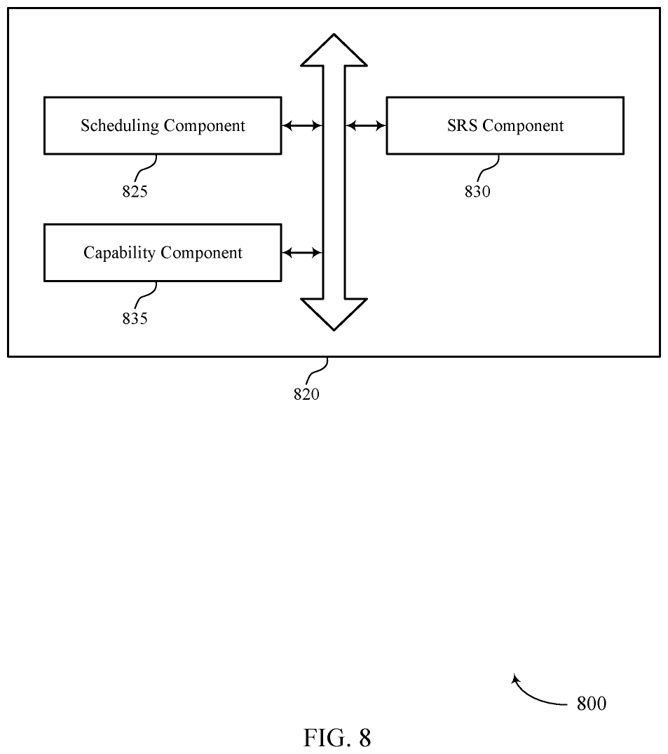

FIG. 8 shows a block diagram 800 of a communications manager 820 that supports SRS slot schedules for slots with mixed SBFD and non-SBFD symbols in accordance with one or more aspects of the present disclosure. The communications manager 820 may be an example of aspects of a communications manager 620, a communications manager 720, or both, as described herein. The communications manager 820, or various components thereof, may be an example of means for performing various aspects of SRS slot schedules for slots with mixed SBFD and non-SBFD symbols as described herein. For example, the communications manager 820 may include a scheduling component 825, an SRS component 830, a capability component 835, or any combination thereof. Each of these components, or components or subcomponents thereof (e.g., one or more processors, one or more memories), may communicate, directly or indirectly, with one another (e.g., via one or more buses).

The scheduling component 825 is capable of, configured to, or operable to support a means for receiving a schedule for a SRS resource set, the schedule indicating a slot offset for a target slot relative to a reference slot. The SRS component 830 is capable of, configured to, or operable to support a means for transmitting a quantity of SRSs in the target slot, the quantity of transmitted SRSs being based on the target slot including one or more SBFD symbols and one or more non-SBFD symbols and being further based on one or more SRS resources of the SRS resource set overlapping between the one or more SBFD symbols and the one or more non-SBFD symbols.

In some examples, to support transmitting the quantity of SRSs in the target slot, the SRS component 830 is capable of, configured to, or operable to support a means for refraining from transmitting sounding reference signaling via one or more symbols of the one or more SRS resources overlapping between the one or more SBFD symbols and the one or more non-SBFD symbols.

In some examples, to support transmitting the quantity of SRSs in the target slot, the SRS component 830 is capable of, configured to, or operable to support a means for refraining from transmitting sounding reference signaling via the SRS resource set in response to the one or more SRS resources overlapping between the one or more SBFD symbols and the one or more non-SBFD symbols.

In some examples, the one or more SRS resources may be restricted from overlapping between the one or more SBFD symbols and the one or more non-SBFD symbols. For instance, the SRS component 830 may not schedule, allocate, transmit, receive, or expect one or more SRS resources overlapping between the one or more SBFD symbols and the one or more non-SBFD symbols. In some approaches, the SRS component 830 is capable of, configured to, or operable to support a means for detecting an error in response to the one or more SRS resources overlapping between the one or more SBFD symbols and the one or more non-SBFD symbols.

In some examples, to support transmitting the quantity of SRSs in the target slot, the SRS component 830 is capable of, configured to, or operable to support a means for transmitting sounding reference signaling via one or more symbols of the SRS resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols, or any combination thereof.

In some examples, to support transmitting the quantity of SRSs in the target slot, the SRS component 830 is capable of, configured to, or operable to support a means for refraining from transmitting sounding reference signaling via one or more symbols of the SRS resource set scheduled in one or more downlink SBFD symbols of the target slot. In some examples, to support transmitting the quantity of SRSs in the target slot, the SRS component 830 is capable of, configured to, or operable to support a means for transmitting one or more symbols of the SRS resource set scheduled in one or more uplink symbols of the target slot.

In some examples, the capability component 835 is capable of, configured to, or operable to support a means for transmitting an indication of a capability of the UE to support available slot offset scheduling, where the schedule indicating the slot offset is received based on the capability of the UE to support available slot offset scheduling.

In some examples, to support transmitting the quantity of SRSs in the target slot, the SRS component 830 is capable of, configured to, or operable to support a means for refraining from transmitting sounding reference signaling via the SRS resource set in the target slot, the target slot being determined as unavailable based on the one or more SRS resources overlapping between the one or more SBFD symbols and the one or more non-SBFD symbols. In some examples, to support transmitting the quantity of SRSs in the target slot, the SRS component 830 is capable of, configured to, or operable to support a means for transmitting the sounding reference signaling in an available slot (e.g., a next available slot) after the target slot.

In some examples, to support transmitting the quantity of SRSs in the target slot, the SRS component 830 is capable of, configured to, or operable to support a means for transmitting sounding reference signaling, of the SRS resource set, scheduled in the target slot, the target slot being determined as available based on the target slot including the one or more SBFD symbols.

In some examples, to support transmitting the quantity of SRSs in the target slot, the SRS component 830 is capable of, configured to, or operable to support a means for refraining from transmitting sounding reference signaling via one or more downlink symbols, of the SRS resource set, scheduled in the target slot.

In some examples, to support transmitting the quantity of SRSs in the target slot, the SRS component 830 is capable of, configured to, or operable to support a means for transmitting sounding reference signaling via one or more symbols of the SRS resource set in the target slot, the target slot being determined as available based on the SRS resource set not overlapping with one or more downlink resources in the target slot.

In some examples, to support transmitting the quantity of SRSs in the target slot, the SRS component 830 is capable of, configured to, or operable to support a means for refraining from transmitting sounding reference signaling via the SRS resource set in the target slot, the target slot being determined as unavailable based on the SRS resource set overlapping with one or more downlink resources in the target slot.

In some examples, the SRS component 830 is capable of, configured to, or operable to support a means for receiving an indication of a duplex type of the one or more SRS resources of the SRS resource set, where transmitting the quantity of SRSs in the target slot includes refraining from transmitting sounding reference signaling via one or more symbols, of the SRS resource set, scheduled in a resource of the target slot that does not match the duplex type.

In some examples, the SRS component 830 is capable of, configured to, or operable to support a means for receiving an indication of a duplex type of the one or more SRS resources of the SRS resource set, where transmitting the quantity of SRSs in the target slot includes transmitting sounding reference signaling via one or more symbols, of the SRS resource set, scheduled in a resource of the target slot that matches the duplex type.

In some examples, the SRS component 830 is capable of, configured to, or operable to support a means for receiving an indication of a duplex type of the one or more SRS resources of the SRS resource set, where transmitting the quantity of SRSs in the target slot includes refraining from transmitting sounding reference signaling via the one or more SRS resources overlapping between the one or more SBFD symbols and the one or more non-SBFD symbols.

In some examples, the SRS component 830 is capable of, configured to, or operable to support a means for receiving an indication of a duplex type of the one or more SRS resources of the SRS resource set, where transmitting the quantity of SRSs in the target slot includes transmitting sounding reference signaling via one or more symbols, of the SRS resource set, based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols, or any combination thereof.

In some examples, the SRS component 830 is capable of, configured to, or operable to support a means for receiving an indication of a duplex type of the one or more SRS resources of the SRS resource set, where transmitting the quantity of SRSs in the target slot includes refraining from transmitting sounding reference signaling via the SRS resource set in the target slot, the target slot being determined as unavailable in response to the one or more SRS resources overlapping between the one or more SBFD symbols and the one or more non-SBFD symbols.

In some examples, the SRS component 830 is capable of, configured to, or operable to support a means for receiving an indication of a duplex type of the one or more SRS resources of the SRS resource set, where transmitting the quantity of SRSs in the target slot includes transmitting sounding reference signaling via one or more symbols, of the SRS resource set, in the target slot, where the sounding reference signaling is transmitted in the one or more SBFD symbols and not in the one or more non-SBFD symbols, or where the sounding reference signaling is transmitted in the one or more non-SBFD symbols and not in the one or more SBFD symbols.

In some examples, the sounding reference signaling is transmitted in the one or more SBFD symbols and not in the one or more non-SBFD symbols of the target slot determined as an SBFD slot or is transmitted in the one or more non-SBFD symbols and not in the one or more SBFD symbols of the target slot determined as a non-SBFD slot based on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot.

In some examples, the SRS component 830 is capable of, configured to, or operable to support a means for receiving an indication of a duplex type of the one or more SRS resources of the SRS resource set, where transmitting the quantity of SRSs in the target slot includes transmitting sounding reference signaling via one or more symbols, of the SRS resource set, in the target slot, where the sounding reference signaling is transmitted in the one or more SBFD symbols and in the one or more non-SBFD symbols.

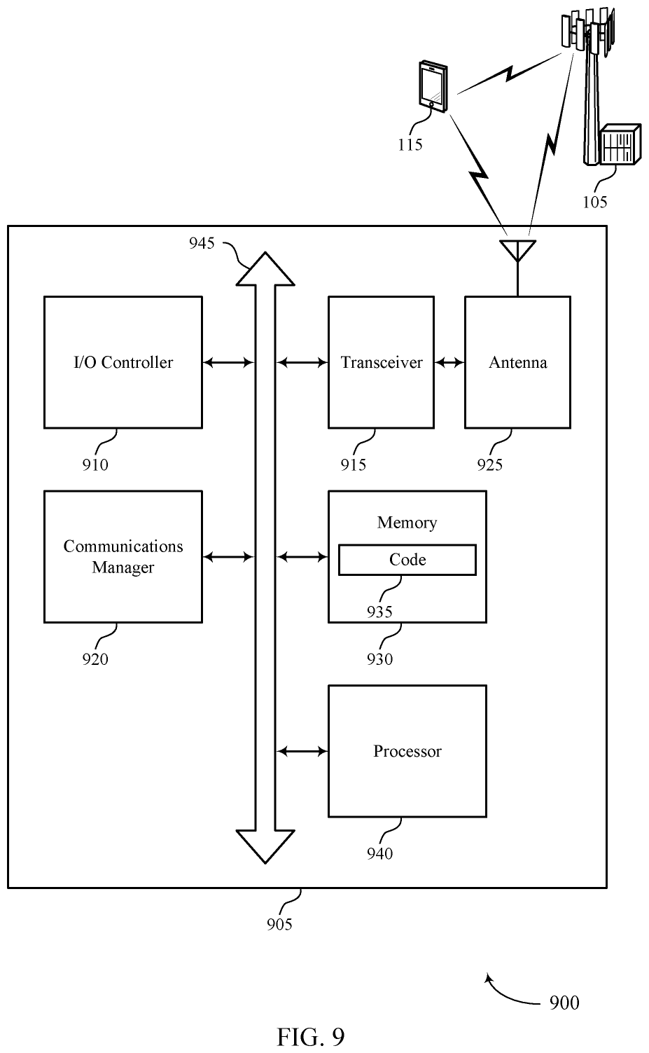

FIG. 9 shows a diagram of a system 900 including a device 905 that supports SRS slot schedules for slots with mixed SBFD and non-SBFD symbols in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a GPU, an NPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting SRS slot schedules for slots with mixed SBFD and non-SBFD symbols). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for receiving a schedule for a SRS resource set, the schedule indicating a slot offset for a target slot relative to a reference slot. The communications manager 920 is capable of, configured to, or operable to support a means for transmitting a quantity of SRSs in the target slot, the quantity of transmitted SRSs being based on the target slot including one or more SBFD symbols and one or more non-SBFD symbols and being further based on one or more SRS resources of the SRS resource set overlapping between the one or more SBFD symbols and the one or more non-SBFD symbols.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of SRS slot schedules for slots with mixed SBFD and non-SBFD symbols as described herein, or the at least one processor 940 and the at least one memory 930 may be otherwise configured to, individually or collectively, perform or support such operations.

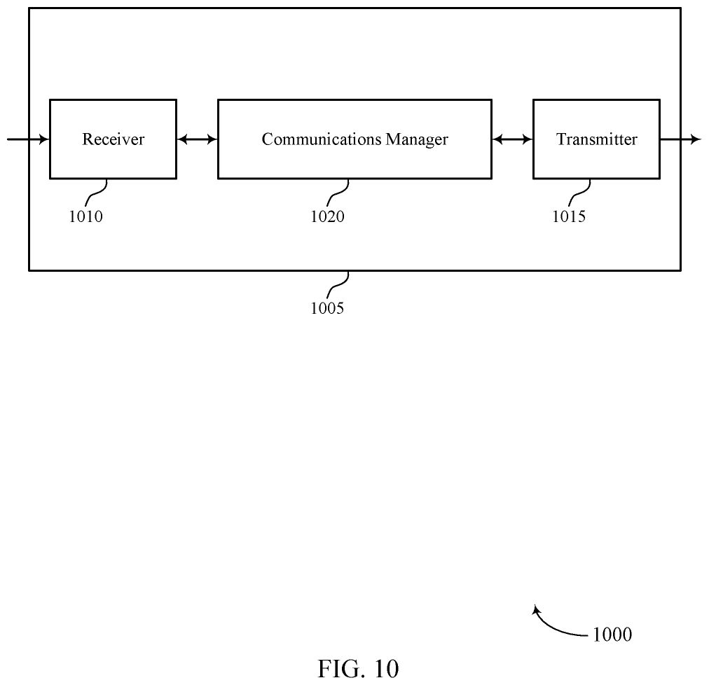

FIG. 10 shows a block diagram 1000 of a device 1005 that supports SRS slot schedules for slots with mixed SBFD and non-SBFD symbols in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of SRS slot schedules for slots with mixed SBFD and non-SBFD symbols as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, a GPU, an NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor. If implemented in code executed by at least one processor, the functions of the communications manager 1020, the receiver 1010, the transmitter 1015, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for transmitting a schedule for a SRS resource set, the schedule indicating a slot offset for a target slot relative to a reference slot. The communications manager 1020 is capable of, configured to, or operable to support a means for receiving a quantity of SRSs in the target slot, the quantity of received SRSs being based on the target slot including one or more SBFD symbols and one or more non-SBFD symbols and being further based on one or more SRS resources of the SRS resource set overlapping between the one or more SBFD symbols and the one or more non-SBFD symbols.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, or more efficient utilization of communication resources).

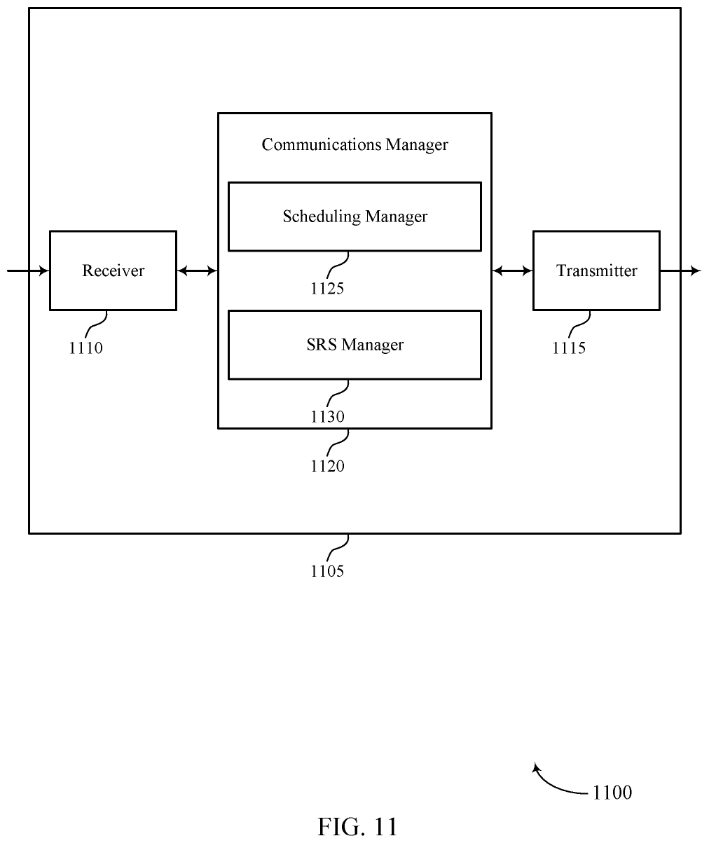

FIG. 11 shows a block diagram 1100 of a device 1105 that supports SRS slot schedules for slots with mixed SBFD and non-SBFD symbols in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of SRS slot schedules for slots with mixed SBFD and non-SBFD symbols as described herein. For example, the communications manager 1120 may include a scheduling manager 1125 an SRS manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The scheduling manager 1125 is capable of, configured to, or operable to support a means for transmitting a schedule for a SRS resource set, the schedule indicating a slot offset for a target slot relative to a reference slot. The SRS manager 1130 is capable of, configured to, or operable to support a means for receiving a quantity of SRSs in the target slot, the quantity of received SRSs being based on the target slot including one or more SBFD symbols and one or more non-SBFD symbols and being further based on one or more SRS resources of the SRS resource set overlapping between the one or more SBFD symbols and the one or more non-SBFD symbols.

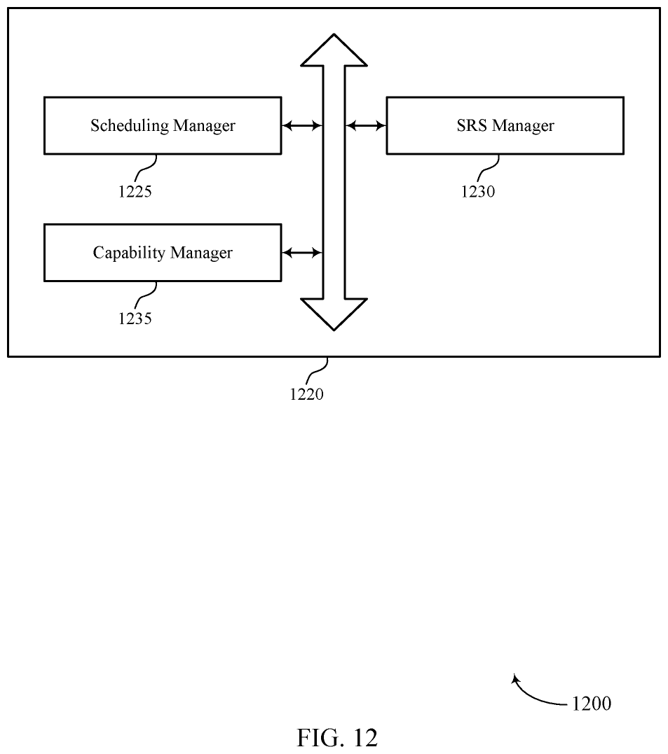

FIG. 12 shows a block diagram 1200 of a communications manager 1220 that supports SRS slot schedules for slots with mixed SBFD and non-SBFD symbols in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of SRS slot schedules for slots with mixed SBFD and non-SBFD symbols as described herein. For example, the communications manager 1220 may include a scheduling manager 1225, an SRS manager 1230, a capability manager 1235, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The scheduling manager 1225 is capable of, configured to, or operable to support a means for transmitting a schedule for a SRS resource set, the schedule indicating a slot offset for a target slot relative to a reference slot. The SRS manager 1230 is capable of, configured to, or operable to support a means for receiving a quantity of SRSs in the target slot, the quantity of received SRSs being based on the target slot including one or more SBFD symbols and one or more non-SBFD symbols and being further based on one or more SRS resources of the SRS resource set overlapping between the one or more SBFD symbols and the one or more non-SBFD symbols.

In some examples, to support receiving the quantity of SRSs in the target slot, the SRS manager 1230 is capable of, configured to, or operable to support a means for refraining from receiving sounding reference signaling via one or more symbols of the one or more SRS resources overlapping between the one or more SBFD symbols and the one or more non-SBFD symbols.

In some examples, to support receiving the quantity of SRSs in the target slot, the SRS manager 1230 is capable of, configured to, or operable to support a means for refraining from receiving sounding reference signaling via the SRS resource set in response to the one or more SRS resources overlapping between the one or more SBFD symbols and the one or more non-SBFD symbols.

In some examples, the one or more SRS resources may be restricted from overlapping between the one or more SBFD symbols and the one or more non-SBFD symbols. For instance, the SRS manager 1230 may not schedule, allocate, transmit, receive, or expect one or more SRS resources overlapping between the one or more SBFD symbols and the one or more non-SBFD symbols. In some approaches, the SRS manager 1230 is capable of, configured to, or operable to support a means for detecting an error in response to the one or more SRS resources overlapping between the one or more SBFD symbols and the one or more non-SBFD symbols.

In some examples, to support receiving the quantity of SRSs in the target slot, the SRS manager 1230 is capable of, configured to, or operable to support a means for receiving sounding reference signaling via one or more symbols of the SRS resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols, or any combination thereof.

In some examples, to support receiving the quantity of SRSs in the target slot, the SRS manager 1230 is capable of, configured to, or operable to support a means for refraining from receiving sounding reference signaling via one or more symbols of the SRS resource set scheduled in one or more downlink SBFD symbols of the target slot. In some examples, to support receiving the quantity of SRSs in the target slot, the SRS manager 1230 is capable of, configured to, or operable to support a means for receiving one or more symbols of the SRS resource set scheduled in one or more uplink symbols of the target slot.

In some examples, the capability manager 1235 is capable of, configured to, or operable to support a means for receiving an indication of a capability of a UE to support available slot offset scheduling, where the schedule indicating the slot offset is transmitted based on the capability of the UE to support available slot offset scheduling.

In some examples, to support receiving the quantity of SRSs in the target slot, the SRS manager 1230 is capable of, configured to, or operable to support a means for refraining from receiving sounding reference signaling via the SRS resource set in the target slot, the target slot being determined as unavailable based on the one or more SRS resources overlapping between the one or more SBFD symbols and the one or more non-SBFD symbols. In some examples, to support receiving the quantity of SRSs in the target slot, the SRS manager 1230 is capable of, configured to, or operable to support a means for receiving the sounding reference signaling in an available slot (e.g., a next available slot) after the target slot.

In some examples, to support receiving the quantity of SRSs in the target slot, the SRS manager 1230 is capable of, configured to, or operable to support a means for receiving sounding reference signaling, of the SRS resource set, scheduled in the target slot, the target slot being determined as available based on the target slot including the one or more SBFD symbols.

In some examples, to support receiving the quantity of SRSs in the target slot, the SRS manager 1230 is capable of, configured to, or operable to support a means for refraining from receiving sounding reference signaling via one or more downlink symbols of the SRS resource set scheduled in of the target slot.

In some examples, to support receiving the quantity of SRSs in the target slot, the SRS manager 1230 is capable of, configured to, or operable to support a means for receiving sounding reference signaling via one or more symbols of the SRS resource set in the target slot, the target slot being determined as available based on the SRS resource set not overlapping with one or more downlink resources in the target slot.

In some examples, to support receiving the quantity of SRSs in the target slot, the SRS manager 1230 is capable of, configured to, or operable to support a means for refraining from receiving sounding reference signaling via the SRS resource set in the target slot, the target slot being determined as unavailable based on the SRS resource set overlapping with one or more downlink resources in the target slot.

In some examples, the SRS manager 1230 is capable of, configured to, or operable to support a means for transmitting an indication of a duplex type of the one or more SRS resources of the SRS resource set, where receiving the quantity of SRSs in the target slot includes refraining from receiving sounding reference signaling via one or more symbols, of the SRS resource set, scheduled in a resource of the target slot that does not match the duplex type.

In some examples, the SRS manager 1230 is capable of, configured to, or operable to support a means for transmitting an indication of a duplex type of the one or more SRS resources of the SRS resource set, where receiving the quantity of SRSs in the target slot includes receiving sounding reference signaling via one or more symbols, of the SRS resource set, scheduled in a resource of the target slot that matches the duplex type.

In some examples, the SRS manager 1230 is capable of, configured to, or operable to support a means for transmitting an indication of a duplex type of the one or more SRS resources of the SRS resource set, where receiving the quantity of SRSs in the target slot includes refraining from receiving sounding reference signaling via the one or more SRS resources overlapping between the one or more SBFD symbols and the one or more non-SBFD symbols.

In some examples, the SRS manager 1230 is capable of, configured to, or operable to support a means for transmitting an indication of a duplex type of the one or more SRS resources of the SRS resource set, where receiving the quantity of SRSs in the target slot includes receiving sounding reference signaling via one or more symbols of the SRS resource set based on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols, or any combination thereof.

In some examples, the SRS manager 1230 is capable of, configured to, or operable to support a means for transmitting an indication of a duplex type of the one or more SRS resources of the SRS resource set, where receiving the quantity of SRSs in the target slot includes refraining from receiving sounding reference signaling via the SRS resource set in the target slot, the target slot being determined as unavailable in response to the one or more SRS resources overlapping between the one or more SBFD symbols and the one or more non-SBFD symbols.

In some examples, the SRS manager 1230 is capable of, configured to, or operable to support a means for transmitting an indication of a duplex type of the one or more SRS resources of the SRS resource set, where receiving the quantity of SRSs in the target slot includes receiving sounding reference signaling via one or more symbols, of the SRS resource set, in the target slot, where the sounding reference signaling is received in the one or more SBFD symbols and not in the one or more non-SBFD symbols, or where the sounding reference signaling is received in the one or more non-SBFD symbols and not in the one or more SBFD symbols.

In some examples, the sounding reference signaling is received in the one or more SBFD symbols and not in the one or more non-SBFD symbols of the target slot determined as an SBFD slot, or is received in the one or more non-SBFD symbols and not in the one or more SBFD symbols of the target slot determined as a non-SBFD slot based on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot.

In some examples, the SRS manager 1230 is capable of, configured to, or operable to support a means for transmitting an indication of a duplex type of the one or more SRS resources of the SRS resource set, where receiving the quantity of SRSs in the target slot includes receiving sounding reference signaling via one or more symbols, of the SRS resource set, in the target slot, where the sounding reference signaling is transmitted in the one or more SBFD symbols and in the one or more non-SBFD symbols.

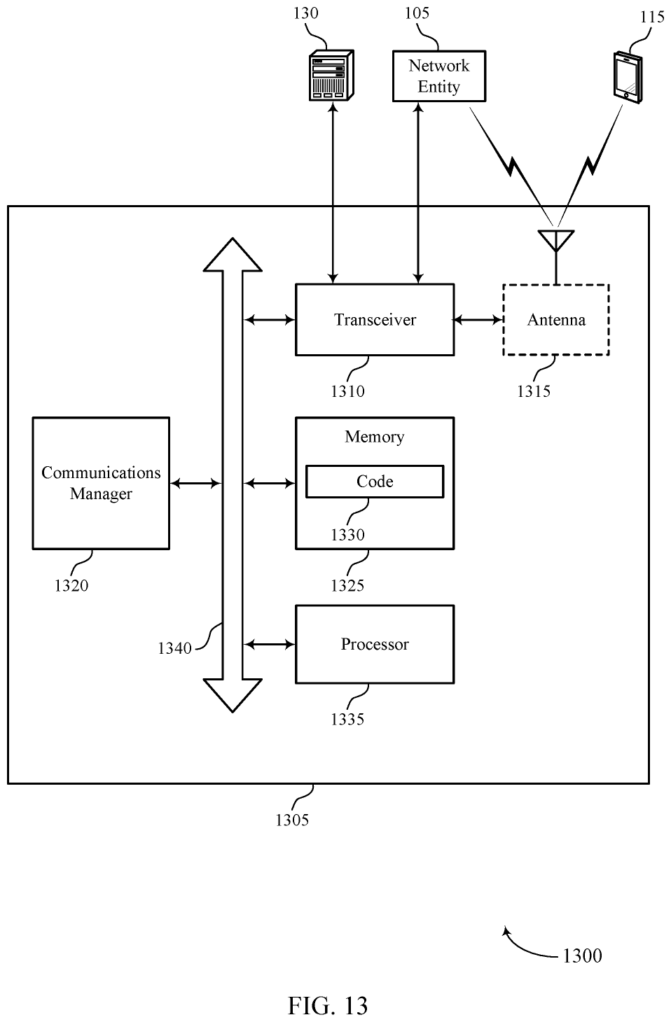

FIG. 13 shows a diagram of a system 1300 including a device 1305 that supports SRS slot schedules for slots with mixed SBFD and non-SBFD symbols in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, a GPU, an NPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting SRS slot schedules for slots with mixed SBFD and non-SBFD symbols). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for transmitting a schedule for a SRS resource set, the schedule indicating a slot offset for a target slot relative to a reference slot. The communications manager 1320 is capable of, configured to, or operable to support a means for receiving a quantity of SRSs in the target slot, the quantity of received SRSs being based on the target slot including one or more SBFD symbols and one or more non-SBFD symbols and being further based on one or more SRS resources of the SRS resource set overlapping between the one or more SBFD symbols and the one or more non-SBFD symbols.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of SRS slot schedules for slots with mixed SBFD and non-SBFD symbols as described herein, or the at least one processor 1335 and the at least one memory 1325 may be otherwise configured to, individually or collectively, perform or support such operations.

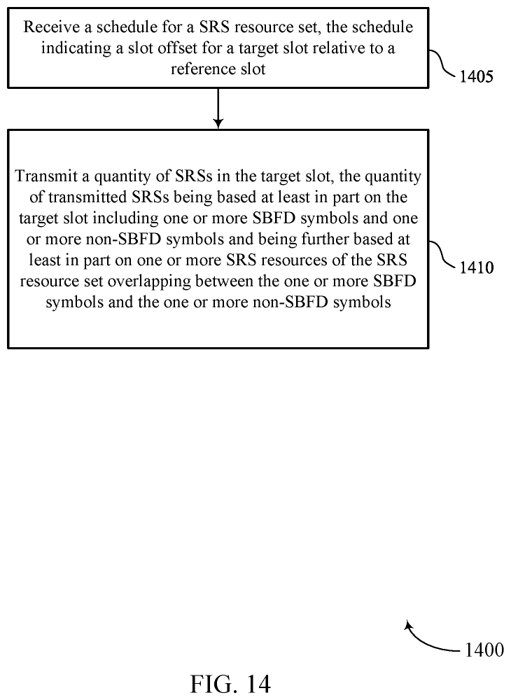

FIG. 14 shows a flowchart illustrating a method 1400 that supports SRS slot schedules for slots with mixed SBFD and non-SBFD symbols in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a schedule for a SRS resource set, the schedule indicating a slot offset for a target slot relative to a reference slot. The operations of block 1405 may be performed in accordance with examples as disclosed herein. In some examples, aspects of the operations of 1405 may be performed by a scheduling component 825 as described with reference to FIG. 8.

At 1410, the method may include transmitting a quantity of SRSs in the target slot, the quantity of transmitted SRSs being based at least in part on the target slot including one or more SBFD symbols and one or more non-SBFD symbols and being further based at least in part on one or more SRS resources of the SRS resource set overlapping between the one or more SBFD symbols and the one or more non-SBFD symbols. The operations of block 1410 may be performed in accordance with examples as disclosed herein. In some examples, aspects of the operations of 1410 may be performed by an SRS component 830 as described with reference to FIG. 8.

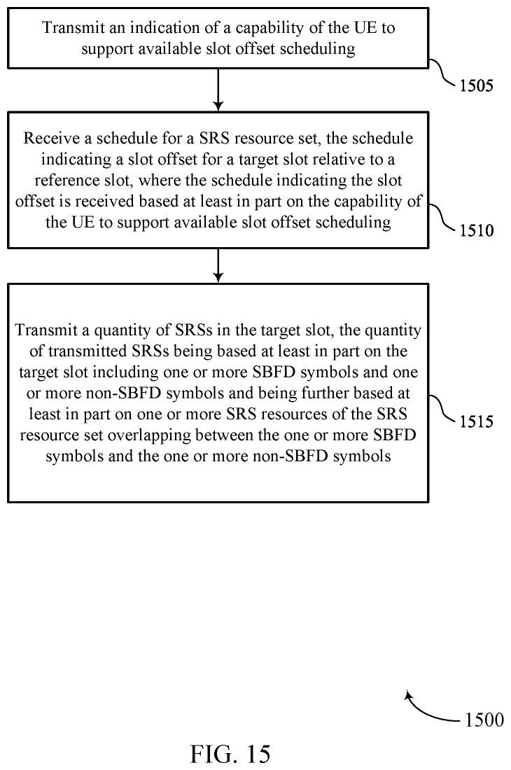

FIG. 15 shows a flowchart illustrating a method 1500 that supports SRS slot schedules for slots with mixed SBFD and non-SBFD symbols in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting an indication of a capability of the UE to support available slot offset scheduling. The operations of block 1505 may be performed in accordance with examples as disclosed herein. In some examples, aspects of the operations of 1505 may be performed by a capability component 835 as described with reference to FIG. 8.

At 1510, the method may include receiving a schedule for a SRS resource set, the schedule indicating a slot offset for a target slot relative to a reference slot, where the schedule indicating the slot offset is received based at least in part on the capability of the UE to support available slot offset scheduling. The operations of block 1510 may be performed in accordance with examples as disclosed herein. In some examples, aspects of the operations of 1510 may be performed by a scheduling component 825 as described with reference to FIG. 8.

At 1515, the method may include transmitting a quantity of SRSs in the target slot, the quantity of transmitted SRSs being based at least in part on the target slot including one or more SBFD symbols and one or more non-SBFD symbols and being further based at least in part on one or more SRS resources of the SRS resource set overlapping between the one or more SBFD symbols and the one or more non-SBFD symbols. The operations of block 1515 may be performed in accordance with examples as disclosed herein. In some examples, aspects of the operations of 1515 may be performed by an SRS component 830 as described with reference to FIG. 8.

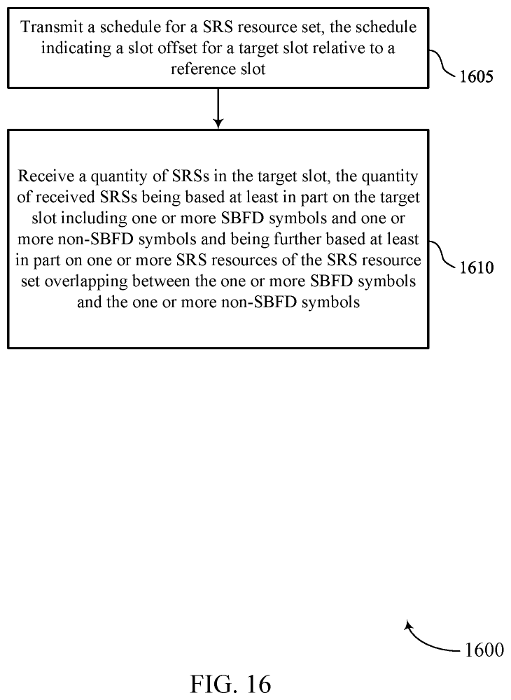

FIG. 16 shows a flowchart illustrating a method 1600 that supports SRS slot schedules for slots with mixed SBFD and non-SBFD symbols in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a schedule for a SRS resource set, the schedule indicating a slot offset for a target slot relative to a reference slot. The operations of block 1605 may be performed in accordance with examples as disclosed herein. In some examples, aspects of the operations of 1605 may be performed by a scheduling manager 1225 as described with reference to FIG. 12.

At 1610, the method may include receiving a quantity of SRSs in the target slot, the quantity of received SRSs being based at least in part on the target slot including one or more SBFD symbols and one or more non-SBFD symbols and being further based at least in part on one or more SRS resources of the SRS resource set overlapping between the one or more SBFD symbols and the one or more non-SBFD symbols. The operations of block 1610 may be performed in accordance with examples as disclosed herein. In some examples, aspects of the operations of 1610 may be performed by an SRS manager 1230 as described with reference to FIG. 12.

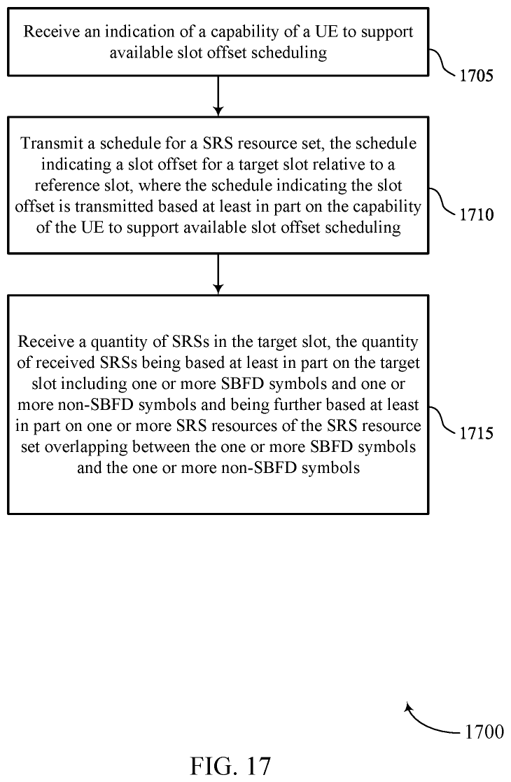

FIG. 17 shows a flowchart illustrating a method 1700 that supports SRS slot schedules for slots with mixed SBFD and non-SBFD symbols in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving an indication of a capability of a UE to support available slot offset scheduling. The operations of block 1705 may be performed in accordance with examples as disclosed herein. In some examples, aspects of the operations of 1705 may be performed by a capability manager 1235 as described with reference to FIG. 12.

At 1710, the method may include transmitting a schedule for a SRS resource set, the schedule indicating a slot offset for a target slot relative to a reference slot, where the schedule indicating the slot offset is transmitted based at least in part on the capability of the UE to support available slot offset scheduling. The operations of block 1710 may be performed in accordance with examples as disclosed herein. In some examples, aspects of the operations of 1710 may be performed by a scheduling manager 1225 as described with reference to FIG. 12.

At 1715, the method may include receiving a quantity of SRSs in the target slot, the quantity of received SRSs being based at least in part on the target slot including one or more SBFD symbols and one or more non-SBFD symbols and being further based at least in part on one or more SRS resources of the SRS resource set overlapping between the one or more SBFD symbols and the one or more non-SBFD symbols. The operations of block 1715 may be performed in accordance with examples as disclosed herein. In some examples, aspects of the operations of 1715 may be performed by an SRS manager 1230 as described with reference to FIG. 12.

The following provides an overview of aspects of the present disclosure:

Aspect 1: A method for wireless communications by a UE, comprising: receiving a schedule for a sounding reference signal resource set, the schedule indicating a slot offset for a target slot relative to a reference slot; and transmitting a quantity of sounding reference signals in the target slot, the quantity of transmitted sounding reference signals being based at least in part on the target slot comprising one or more SBFD symbols and one or more non-SBFD symbols and being further based at least in part on one or more sounding reference signal resources of the sounding reference signal resource set overlapping between the one or more SBFD symbols and the one or more non-SBFD symbols.

Aspect 2: The method of aspect 1, wherein transmitting the quantity of sounding reference signals in the target slot comprises: refraining from transmitting sounding reference signaling via one or more symbols of the one or more sounding reference signal resources overlapping between the one or more SBFD symbols and the one or more non-SBFD symbols.

Aspect 3: The method of any of aspects 1 through 2, wherein transmitting the quantity of sounding reference signals in the target slot comprises: refraining from transmitting sounding reference signaling via the sounding reference signal resource set in response to the one or more sounding reference signal resources overlapping between the one or more SBFD symbols and the one or more non-SBFD symbols.

Aspect 4: The method of aspect 3, wherein the one or more sounding reference signal resources are restricted from overlapping between the one or more SBFD symbols and the one or more non-SBFD symbols.

Aspect 5: The method of any of aspects 1 through 2, wherein transmitting the quantity of sounding reference signals in the target slot comprises: transmitting sounding reference signaling via one or more symbols of the sounding reference signal resource set based at least in part on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

Aspect 6: The method of any of aspects 1 through 2 and 5, wherein transmitting the quantity of sounding reference signals in the target slot comprises: refraining from transmitting sounding reference signaling via one or more symbols of the sounding reference signal resource set scheduled in one or more downlink SBFD symbols of the target slot; and transmitting one or more symbols of the sounding reference signal resource set scheduled in one or more uplink symbols of the target slot.

Aspect 7: The method of any of aspects 1 through 6, further comprising: transmitting an indication of a capability of the UE to support available slot offset scheduling, wherein the schedule indicating the slot offset is received based at least in part on the capability of the UE to support available slot offset scheduling.

Aspect 8: The method of any of aspects 1, 3, 4, and 7, wherein transmitting the quantity of sounding reference signals in the target slot comprises: refraining from transmitting sounding reference signaling via the sounding reference signal resource set in the target slot, the target slot being determined as unavailable based at least in part on the one or more sounding reference signal resources overlapping between the one or more SBFD symbols and the one or more non-SBFD symbols; and transmitting the sounding reference signaling in a next available slot after the target slot.

Aspect 9: The method of any of aspects 1, 2, and 5 through 7, wherein transmitting the quantity of sounding reference signals in the target slot comprises: transmitting sounding reference signaling, of the sounding reference signal resource set, scheduled in the target slot, the target slot being determined as available based at least in part on the target slot comprising the one or more SBFD symbols.

Aspect 10: The method of aspect 9, wherein transmitting the quantity of sounding reference signals in the target slot comprises: refraining from transmitting sounding reference signaling via one or more downlink symbols, of the sounding reference signal resource set, scheduled in the target slot.

Aspect 11: The method of any of aspects 1, 2, 5 through 7, 9, and 10, wherein transmitting the quantity of sounding reference signals in the target slot comprises: transmitting sounding reference signaling via one or more symbols of the sounding reference signal resource set in the target slot, the target slot being determined as available based at least in part on the sounding reference signal resource set not overlapping with one or more downlink resources in the target slot.

Aspect 12: The method of any of aspects 1, 3, 4, 7, and 8, wherein transmitting the quantity of sounding reference signals in the target slot comprises: refraining from transmitting sounding reference signaling via the sounding reference signal resource set in the target slot, the target slot being determined as unavailable based at least in part on the sounding reference signal resource set overlapping with one or more downlink resources in the target slot.

Aspect 13: The method of any of aspects 1 through 12, further comprising: receiving an indication of a duplex type of the one or more sounding reference signal resources of the sounding reference signal resource set, wherein transmitting the quantity of sounding reference signals in the target slot comprises refraining from transmitting sounding reference signaling via one or more symbols, of the sounding reference signal resource set, scheduled in a resource of the target slot that does not match the duplex type.

Aspect 14: The method of any of aspects 1, 2, 5 through 7, 9, 10, and 11, further comprising: receiving an indication of a duplex type of the one or more sounding reference signal resources of the sounding reference signal resource set, wherein transmitting the quantity of sounding reference signals in the target slot comprises transmitting sounding reference signaling via one or more symbols, of the sounding reference signal resource set, scheduled in a resource of the target slot that matches the duplex type.

Aspect 15: The method of any of aspects 1, 3, 4, 7, 8, and 12, further comprising: receiving an indication of a duplex type of the one or more sounding reference signal resources of the sounding reference signal resource set, wherein transmitting the quantity of sounding reference signals in the target slot comprises refraining from transmitting sounding reference signaling via the one or more sounding reference signal resources overlapping between the one or more SBFD symbols and the one or more non-SBFD symbols.

Aspect 16: The method of any of aspects 1, 2, 5 through 7, 9 through 11, and 14, further comprising: receiving an indication of a duplex type of the one or more sounding reference signal resources of the sounding reference signal resource set, wherein transmitting the quantity of sounding reference signals in the target slot comprises transmitting sounding reference signaling via one or more symbols, of the sounding reference signal resource set, based at least in part on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

Aspect 17: The method of any of aspects 1, 3, 4, 7, 8, 12, and 15, further comprising: receiving an indication of a duplex type of the one or more sounding reference signal resources of the sounding reference signal resource set, wherein transmitting the quantity of sounding reference signals in the target slot comprises refraining from transmitting sounding reference signaling via the sounding reference signal resource set in the target slot, the target slot being determined as unavailable in response to the one or more sounding reference signal resources overlapping between the one or more SBFD symbols and the one or more non-SBFD symbols.

Aspect 18: The method of any of aspects 1, 2, 5 through 7, 9 through 11, 14, and 16, further comprising: receiving an indication of a duplex type of the one or more sounding reference signal resources of the sounding reference signal resource set, wherein transmitting the quantity of sounding reference signals in the target slot comprises transmitting sounding reference signaling via one or more symbols, of the sounding reference signal resource set, in the target slot, wherein the sounding reference signaling is transmitted in the one or more SBFD symbols and not in the one or more non-SBFD symbols, or wherein the sounding reference signaling is transmitted in the one or more non-SBFD symbols and not in the one or more SBFD symbols.

Aspect 19: The method of aspect 18, wherein the sounding reference signaling is transmitted in the one or more SBFD symbols and not in the one or more non-SBFD symbols of the target slot determined as a sub-band full duplex slot or is transmitted in the one or more non-SBFD symbols and not in the one or more SBFD symbols of the target slot determined as a non-SBFD slot, based at least in part on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot.

Aspect 20: The method of any of aspects 1, 5, 7, 9, 11, 14, and 16, further comprising: receiving an indication of a duplex type of the one or more sounding reference signal resources of the sounding reference signal resource set, wherein transmitting the quantity of sounding reference signals in the target slot comprises transmitting sounding reference signaling via one or more symbols, of the sounding reference signal resource set, in the target slot, wherein the sounding references signaling is transmitted in the one or more SBFD symbols and in the one or more non-SBFD symbols.

Aspect 21: A method for wireless communications by a network entity, comprising: transmitting a schedule for a sounding reference signal resource set, the schedule indicating a slot offset for a target slot relative to a reference slot; and receiving a quantity of sounding reference signals in the target slot, the quantity of received sounding reference signals being based at least in part on the target slot comprising one or more SBFD symbols and one or more non-SBFD symbols and being further based at least in part on one or more sounding reference signal resources of the sounding reference signal resource set overlapping between the one or more SBFD symbols and the one or more non-SBFD symbols.

Aspect 22: The method of aspect 21, wherein receiving the quantity of sounding reference signals in the target slot comprises: refraining from receiving sounding reference signaling via at least one of the one or more sounding reference signal resources overlapping between the one or more SBFD symbols and the one or more non-SBFD symbols.

Aspect 23: The method of any of aspects 21 through 22, wherein receiving the quantity of sounding reference signals in the target slot comprises: refraining from receiving sounding reference signaling via the sounding reference signal resource set in response to the one or more sounding reference signal resources overlapping between the one or more SBFD symbols and the one or more non-SBFD symbols.

Aspect 24: The method of aspect 23, wherein the one or more sounding reference signal resources are restricted from overlapping between the one or more SBFD symbols and the one or more non-SBFD symbols.

Aspect 25: The method of any of aspects 21 through 22, wherein receiving the quantity of sounding reference signals in the target slot comprises: receiving sounding reference signaling via one or more symbols of the sounding reference signal resource set based at least in part on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

Aspect 26: The method of any of aspects 21 through 22 and 25, wherein receiving the quantity of sounding reference signals in the target slot comprises: refraining from receiving sounding reference signaling via one or more symbols of the sounding reference signal resource set scheduled in one or more downlink SBFD symbols of the target slot; and receiving one or more symbols of the sounding reference signal resource set scheduled in one or more uplink symbols of the target slot.

Aspect 27: The method of any of aspects 21 through 26, further comprising: receiving an indication of a capability of a UE to support available slot offset scheduling, wherein the schedule indicating the slot offset is transmitted based at least in part on the capability of the UE to support available slot offset scheduling.

Aspect 28: The method of any of aspects 21, 23, 24, and 27, wherein receiving the quantity of sounding reference signals in the target slot comprises: refraining from receiving sounding reference signaling via the sounding reference signal resource set in the target slot, the target slot being determined as unavailable based at least in part on the one or more sounding reference signal resources overlapping between the one or more SBFD symbols and the one or more non-SBFD symbols; and receiving the sounding reference signaling in a next available slot after the target slot.

Aspect 29: The method of any of aspects 21, 22, 25 through 27, and 28, wherein receiving the quantity of sounding reference signals in the target slot comprises: receiving sounding reference signaling, of the sounding reference signal resource set, scheduled in the target slot, the target slot being determined as available based at least in part on the target slot comprising the one or more SBFD symbols.

Aspect 30: The method of aspect 29, wherein receiving the quantity of sounding reference signals in the target slot comprises: refraining from receiving sounding reference signaling via one or more downlink symbols of the sounding reference signal resource set scheduled in of the target slot.

Aspect 31: The method of any of aspects 21, 22, 25 through 27, 29, and 30, wherein receiving the quantity of sounding reference signals in the target slot comprises: receiving sounding reference signaling via one or more symbols of the sounding reference signal resource set in the target slot, the target slot being determined as available based at least in part on the sounding reference signal resource set not overlapping with one or more downlink resources in the target slot.

Aspect 32: The method of any of aspects 21, 23, 24, 27, and 28, wherein receiving the quantity of sounding reference signals in the target slot comprises: refraining from receiving sounding reference signaling via the sounding reference signal resource set in the target slot, the target slot being determined as unavailable based at least in part on the sounding reference signal resource set overlapping with one or more downlink resources in the target slot.

Aspect 33: The method of any of aspects 21 through 32, further comprising: transmitting an indication of a duplex type of the one or more sounding reference signal resources of the sounding reference signal resource set, wherein receiving the quantity of sounding reference signals in the target slot comprises refraining from receiving sounding reference signaling via one or more symbols, of the sounding reference signal resource set, scheduled in a resource of the target slot that does not match the duplex type.

Aspect 34: The method of any of aspects 21, 22, 25 through 27, and 29 through 31, further comprising: transmitting an indication of a duplex type of the one or more sounding reference signal resources of the sounding reference signal resource set, wherein receiving the quantity of sounding reference signals in the target slot comprises receiving sounding reference signaling via one or more symbols, of the sounding reference signal resource set, scheduled in a resource of the target slot that matches the duplex type.

Aspect 35: The method of any of aspects 21, 23, 24, 27, 28, and 32, further comprising: transmitting an indication of a duplex type of the one or more sounding reference signal resources of the sounding reference signal resource set, wherein receiving the quantity of sounding reference signals in the target slot comprises refraining from receiving sounding reference signaling via the one or more sounding reference signal resources overlapping between the one or more SBFD symbols and the one or more non-SBFD symbols.

Aspect 36: The method of any of aspects 21, 22, 25 through 27, 29 through 31, and 34, further comprising: transmitting an indication of a duplex type of the one or more sounding reference signal resources of the sounding reference signal resource set, wherein receiving the quantity of sounding reference signals in the target slot comprises receiving sounding reference signaling via one or more symbols of the sounding reference signal resource set based at least in part on a phase continuity condition between the one or more SBFD symbols and the one or more non-SBFD symbols, a communication parameter condition between the one or more SBFD symbols and the one or more non-SBFD symbols, or a guard period condition between the one or more SBFD symbols and the one or more non-SBFD symbols.

Aspect 37: The method of any of aspects 21, 23, 24, 27, 28, 32, and 35, further comprising: transmitting an indication of a duplex type of the one or more sounding reference signal resources of the sounding reference signal resource set, wherein receiving the quantity of sounding reference signals in the target slot comprises refraining from receiving sounding reference signaling via the sounding reference signal resource set in the target slot, the target slot being determined as unavailable in response to the one or more sounding reference signal resources overlapping between the one or more SBFD symbols and the one or more non-SBFD symbols.

Aspect 38: The method of any of aspects 21, 22, 25 through 27, 29 through 31, 34, and 36, further comprising: transmitting an indication of a duplex type of the one or more sounding reference signal resources of the sounding reference signal resource set, wherein receiving the quantity of sounding reference signals in the target slot comprises receiving sounding reference signaling via one or more symbols, of the sounding reference signal resource set, in the target slot, wherein the sounding reference signaling is received in the one or more SBFD symbols and not in the one or more non-SBFD symbols, or wherein the sounding reference signaling is received in the one or more non-SBFD symbols and not in the one or more SBFD symbols.

Aspect 39: The method of aspect 38, wherein the sounding reference signaling is received in the one or more SBFD symbols and not in the one or more non-SBFD symbols of the target slot determined as a SBFD slot, or is received in the one or more non-SBFD symbols and not in the one or more SBFD symbols of the target slot determined as a non-SBFD slot, based at least in part on a quantity of sounding reference signal symbols in the SBFD symbols relative to a quantity of sounding reference signal symbols in the non-SBFD symbols, a quantity of sounding reference signal symbols in the SBFD symbols and in the non-SBFD symbols, or a location of SBFD symbols in the target slot.

Aspect 40: The method of any of aspects 21, 25, 27, 29, 31, 34, and 36, further comprising: transmitting an indication of a duplex type of the one or more sounding reference signal resources of the sounding reference signal resource set, wherein receiving the quantity of sounding reference signals in the target slot comprises receiving sounding reference signaling via one or more symbols, of the sounding reference signal resource set, in the target slot, wherein the sounding reference signaling is transmitted in the one or more SBFD symbols and in the one or more non-SBFD symbols.

Aspect 41: A UE comprising one or more memories storing processor-executable code, and one or more processors coupled with the one or more memories (e.g., operatively, communicatively, functionally, electronically, or electrically) and individually or collectively operable to execute the code (e.g., directly, indirectly, after pre-processing, without pre-processing) to cause the UE to perform a method of any of aspects 1 through 20.

Aspect 42: A UE comprising at least one means for performing a method of any of aspects 1 through 20.

Aspect 43: A non-transitory computer-readable medium storing code for wireless communications at a UE, the code comprising instructions executable by at least one processor (e.g., directly, indirectly, after pre-processing, without pre-processing) to perform a method of any of aspects 1 through 20.

Aspect 44: A network entity comprising one or more memories storing processor-executable code, and one or more processors coupled with the one or more memories (e.g., operatively, communicatively, functionally, electronically, or electrically) and individually or collectively operable to execute the code (e.g., directly, indirectly, after pre-processing, without pre-processing) to cause the network entity to perform a method of any of aspects 21 through 40.

Aspect 45: A network entity comprising at least one means for performing a method of any of aspects 21 through 40.

Aspect 46: A non-transitory computer-readable medium storing code for wireless communications at a network entity, the code comprising instructions executable by at least one processor (e.g., directly, indirectly, after pre-processing, without pre-processing) to perform a method of any of aspects 21 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software (e.g., executed by a processor), or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database, or another data structure), or ascertaining. Also, “determining” or “identifying” can include receiving (such as receiving information or signaling, e.g., receiving information or signaling for determining, receiving information or signaling for identifying), or accessing (such as accessing data in a memory, or accessing information). Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a schedule for a sounding reference signal resource set, the schedule indicating a slot offset for a target slot relative to a reference slot; and
transmit a quantity of sounding reference signals in the target slot, the quantity of transmitted sounding reference signals being based at least in part on the target slot comprising one or more sub-band full-duplex symbols and one or more non-sub-band full-duplex symbols and being further based at least in part on one or more sounding reference signal resources of the sounding reference signal resource set overlapping between the one or more sub-band full-duplex symbols and the one or more non-sub-band full-duplex symbols.

2. The UE of claim 1, wherein, to transmit the quantity of sounding reference signals in the target slot, the one or more processors are individually or collectively operable to execute the code to cause the UE to:
refrain from transmitting sounding reference signaling via one or more symbols of the one or more sounding reference signal resources overlapping between the one or more sub-band full-duplex symbols and the one or more non-sub-band full-duplex symbols.

3. The UE of claim 1, wherein, to transmit the quantity of sounding reference signals in the target slot, the one or more processors are individually or collectively operable to execute the code to cause the UE to:
refrain from transmitting sounding reference signaling via the sounding reference signal resource set in response to the one or more sounding reference signal resources overlapping between the one or more sub-band full-duplex symbols and the one or more non-sub-band full-duplex symbols.

4. The UE of claim 3, wherein the one or more sounding reference signal resources are restricted from overlapping between the one or more sub-band full-duplex symbols and the one or more non-sub-band full-duplex symbols.

5. The UE of claim 1, wherein, to transmit the quantity of sounding reference signals in the target slot, the one or more processors are individually or collectively operable to execute the code to cause the UE to:
transmit sounding reference signaling via one or more symbols of the sounding reference signal resource set based at least in part on a phase continuity condition between the one or more sub-band full-duplex symbols and the one or more non-sub-band full-duplex symbols, a communication parameter condition between the one or more sub-band full-duplex symbols and the one or more non-sub-band full-duplex symbols, or a guard period condition between the one or more sub-band full-duplex symbols and the one or more non-sub-band full-duplex symbols, or any combination thereof.

6. The UE of claim 1, wherein, to transmit the quantity of sounding reference signals in the target slot, the one or more processors are individually or collectively operable to execute the code to cause the UE to:
refrain from transmitting sounding reference signaling via one or more symbols of the sounding reference signal resource set scheduled in one or more downlink sub-band full-duplex symbols of the target slot; and
transmit one or more symbols of the sounding reference signal resource set scheduled in one or more uplink symbols of the target slot.

7. The UE of claim 1, wherein the one or more processors are individually or collectively further operable to execute the code to cause the UE to:
transmit an indication of a capability of the UE to support available slot offset scheduling, wherein the one or more processors are individually or collectively operable to execute the code to cause the UE to receive the schedule indicating the slot offset based at least in part on the capability of the UE to support available slot offset scheduling.

8. The UE of claim 1, wherein, to transmit the quantity of sounding reference signals in the target slot, the one or more processors are individually or collectively operable to execute the code to cause the UE to:
refrain from transmitting sounding reference signaling via the sounding reference signal resource set in the target slot, the target slot being determined as unavailable based at least in part on the one or more sounding reference signal resources overlapping between the one or more sub-band full-duplex symbols and the one or more non-sub-band full-duplex symbols; and
transmit the sounding reference signaling in a next available slot after the target slot.

9. The UE of claim 1, wherein, to transmit the quantity of sounding reference signals in the target slot, the one or more processors are individually or collectively operable to execute the code to cause the UE to:
transmit sounding reference signaling, of the sounding reference signal resource set, scheduled in the target slot, the target slot being determined as available based at least in part on the target slot comprising the one or more sub-band full-duplex symbols.

10. The UE of claim 9, wherein, to transmit the quantity of sounding reference signals in the target slot, the one or more processors are individually or collectively operable to execute the code to cause the UE to:
refrain from transmitting sounding reference signaling via one or more downlink symbols, of the sounding reference signal resource set, scheduled in the target slot.

11. The UE of claim 1, wherein, to transmit the quantity of sounding reference signals in the target slot, the one or more processors are individually or collectively operable to execute the code to cause the UE to:
transmit sounding reference signaling via one or more symbols of the sounding reference signal resource set in the target slot, the target slot being determined as available based at least in part on the sounding reference signal resource set not overlapping with one or more downlink resources in the target slot.

12. The UE of claim 1, wherein, to transmit the quantity of sounding reference signals in the target slot, the one or more processors are individually or collectively operable to execute the code to cause the UE to:
refrain from transmitting sounding reference signaling via the sounding reference signal resource set in the target slot, the target slot being determined as unavailable based at least in part on the sounding reference signal resource set overlapping with one or more downlink resources in the target slot.

13. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
refrain from transmitting sounding reference signaling via one or more symbols, of the sounding reference signal resource set, scheduled in a resource of the target slot that does not match the duplex type.

14. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
transmit sounding reference signaling via one or more symbols, of the sounding reference signal resource set, scheduled in a resource of the target slot that matches the duplex type.

15. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
refrain from transmitting sounding reference signaling via the one or more sounding reference signal resources overlapping between the one or more sub-band full-duplex symbols and the one or more non-sub-band full-duplex symbols.

16. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
transmit sounding reference signaling via one or more symbols, of the sounding reference signal resource set, based at least in part on a phase continuity condition between the one or more sub-band full-duplex symbols and the one or more non-sub-band full-duplex symbols, a communication parameter condition between the one or more sub-band full-duplex symbols and the one or more non-sub-band full-duplex symbols, or a guard period condition between the one or more sub-band full-duplex symbols and the one or more non-sub-band full-duplex symbols, or any combination thereof.

17. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
refrain from transmitting sounding reference signaling via the sounding reference signal resource set in the target slot, the target slot being determined as unavailable in response to the one or more sounding reference signal resources overlapping between the one or more sub-band full-duplex symbols and the one or more non-sub-band full-duplex symbols.

18. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
transmit sounding reference signaling via one or more symbols, of the sounding reference signal resource set, in the target slot, the one or more symbols comprising the one or more sub-band full-duplex symbols and not the one or more non-sub-band full-duplex symbols, or the one or more symbols comprising the one or more non-sub-band full-duplex symbols and not the one or more sub-band full-duplex symbols.

19. The UE of claim 18, wherein the one or more processors are individually or collectively operable to execute the code to cause the UE to transmit the sounding reference signaling in the one or more sub-band full-duplex symbols and not in the one or more non-sub-band full-duplex symbols of the target slot determined as a sub-band full-duplex slot or to transmit the sounding reference signaling in the one or more non-sub-band full-duplex symbols and not in the one or more sub-band full-duplex symbols of the target slot determined as a non-sub-band full-duplex slot, based at least in part on a quantity of sounding reference signal symbols in the sub-band full-duplex symbols relative to a quantity of sounding reference signal symbols in the non-sub-band full-duplex symbols, a quantity of sounding reference signal symbols in the sub-band full-duplex symbols and in the non-sub-band full-duplex symbols, or a location of sub-band full-duplex symbols in the target slot.

20. The UE of claim 1, wherein the one or more processors are individually or collectively further operable to execute the code to cause the UE to:
receive an indication of a duplex type of the one or more sounding reference signal resources of the sounding reference signal resource set, wherein, to transmit the quantity of sounding reference signals in the target slot, the one or more processors are individually or collectively operable to execute the code to cause the UE to:
transmit sounding reference signaling via one or more symbols, of the sounding reference signal resource set, in the target slot, the one or more symbols comprising the one or more sub-band full-duplex symbols and the one or more non-sub-band full-duplex symbols.

21. A network entity, comprising:
one or more memories storing processor-executable code; and
one or more processors coupled with the one or more memories and individually or collectively operable to execute the code to cause the network entity to:
transmit a schedule for a sounding reference signal resource set, the schedule indicating a slot offset for a target slot relative to a reference slot; and
receive a quantity of sounding reference signals in the target slot, the quantity of received sounding reference signals being based at least in part on the target slot comprising one or more sub-band full-duplex symbols and one or more non-sub-band full-duplex symbols and being further based at least in part on one or more sounding reference signal resources of the sounding reference signal resource set overlapping between the one or more sub-band full-duplex symbols and the one or more non-sub-band full-duplex symbols.

22. The network entity of claim 21, wherein, to receive the quantity of sounding reference signals in the target slot, the one or more processors are individually or collectively operable to execute the code to cause the network entity to:
refrain from receiving sounding reference signaling via one or more symbols of the one or more sounding reference signal resources overlapping between the one or more sub-band full-duplex symbols and the one or more non-sub-band full-duplex symbols.

23. The network entity of claim 21, wherein, to receive the quantity of sounding reference signals in the target slot, the one or more processors are individually or collectively operable to execute the code to cause the network entity to:
refrain from receiving sounding reference signaling via the sounding reference signal resource set in response to the one or more sounding reference signal resources overlapping between the one or more sub-band full-duplex symbols and the one or more non-sub-band full-duplex symbols.

24. The network entity of claim 23, wherein the one or more sounding reference signal resources are restricted from overlapping between the one or more sub-band full-duplex symbols and the one or more non-sub-band full-duplex symbols.

25. The network entity of claim 21, wherein, to receive the quantity of sounding reference signals in the target slot, the one or more processors are individually or collectively operable to execute the code to cause the network entity to:
receive sounding reference signaling via one or more symbols of the sounding reference signal resource set based at least in part on a phase continuity condition between the one or more sub-band full-duplex symbols and the one or more non-sub-band full-duplex symbols, a communication parameter condition between the one or more sub-band full-duplex symbols and the one or more non-sub-band full-duplex symbols, or a guard period condition between the one or more sub-band full-duplex symbols and the one or more non-sub-band full-duplex symbols, or any combination thereof.

26. The network entity of claim 21, wherein, to receive the quantity of sounding reference signals in the target slot, the one or more processors are individually or collectively operable to execute the code to cause the network entity to:
refrain from receiving sounding reference signaling via one or more symbols of the sounding reference signal resource set scheduled in one or more downlink sub-band full-duplex symbols of the target slot; and
receive one or more symbols of the sounding reference signal resource set scheduled in one or more uplink symbols of the target slot.

27. The network entity of claim 21, wherein the one or more processors are individually or collectively further operable to execute the code to cause the network entity to:
receive an indication of a capability of a user equipment (UE) to support available slot offset scheduling, wherein the schedule indicating the slot offset is transmitted based at least in part on the capability of the UE to support available slot offset scheduling.

28. The network entity of claim 21, wherein, to receive the quantity of sounding reference signals in the target slot, the one or more processors are individually or collectively operable to execute the code to cause the network entity to:
refrain from receiving sounding reference signaling via the sounding reference signal resource set in the target slot, the target slot being determined as unavailable based at least in part on the one or more sounding reference signal resources overlapping between the one or more sub-band full-duplex symbols and the one or more non-sub-band full-duplex symbols; and
receive the sounding reference signaling in a next available slot after the target slot.

29. A method for wireless communications by a user equipment (UE), comprising:
receiving a schedule for a sounding reference signal resource set, the schedule indicating a slot offset for a target slot relative to a reference slot; and
transmitting a quantity of sounding reference signals in the target slot, the quantity of transmitted sounding reference signals being based at least in part on the target slot comprising one or more sub-band full-duplex symbols and one or more non-sub-band full-duplex symbols and being further based at least in part on one or more sounding reference signal resources of the sounding reference signal resource set overlapping between the one or more sub-band full-duplex symbols and the one or more non-sub-band full-duplex symbols.

30. A method for wireless communications by a network entity, comprising:
transmitting a schedule for a sounding reference signal resource set, the schedule indicating a slot offset for a target slot relative to a reference slot; and
receiving a quantity of sounding reference signals in the target slot, the quantity of received sounding reference signals being based at least in part on the target slot comprising one or more sub-band full-duplex symbols and one or more non-sub-band full-duplex symbols and being further based at least in part on one or more sounding reference signal resources of the sounding reference signal resource set overlapping between the one or more sub-band full-duplex symbols and the one or more non-sub-band full-duplex symbols.
